(19) United States
(12) Patent Application Publication
(10) Pub. No.: US 2025/0362570 A1
(43) Pub. Date: Nov. 27, 2025

(54) IMAGE CAPTURING APPARATUS, ADAPTER, SYSTEM, AND CONTROL METHOD

(71) Applicant: CANON KABUSHIKI KAISHA, Tokyo (JP)

(72) Inventors: SAYURI IDAKA, Tokyo (JP); MOTOYUKI ASANO, Tokyo (JP); SOICHIRO SHIGEEDA, Kanagawa (JP); TAKAHIRO KAMIKURA, Tokyo (JP); YUSUKE YAMASHITA, Kanagawa (JP); KENTO WATANABE, Kanagawa (JP)

(21) Appl. No.: 19/215,035

(22) Filed: May 21, 2025

(30) Foreign Application Priority Data
May 27, 2024 (JP) 2024-085658

(51) Int. Cl. G03B 17/14; G08C 19/00

(52) U.S. Cl. CPC G03B 17/14; G08C 19/00

(57) ABSTRACT

Image capturing apparatuses, adapters, systems, methods, and storage mediums are provided. At least one image capturing apparatus has a first contact unit, a second contact unit, a first communication unit that performs a first communication via the first contact unit, and a second communication unit that performs a second communication via the second contact unit. At least one image capturing apparatus also has a third communication unit that performs a third communication via a predetermined contact unit that is the first contact unit or the second contact unit of the image capturing apparatus. A control unit of at least one image capturing apparatus performs control to recognize a mounted adapter via the first communication or the second communication, transmit an instruction to the adapter after recognizing the adapter, and start the third communication after transmitting the instruction.

### BACKGROUND

### Field of the Disclosure

One or more features of the present disclosure relate to one or more embodiments of an image capturing apparatus, an adapter, a system, and a control method.

### Description of the Related Art

Interchangeable-lens camera systems, in which lenses are attachable/removable and interchangeable, have become widespread. In such systems, a camera obtains lens information by mutually communicating with an interchangeable lens mounted thereon; as a result, appropriate control may be performed with respect to the interchangeable lens, and a user may be notified of the lens information as a result of displaying the lens information on a monitor of the camera.

Also, there is a case where an adapter is mounted between a camera and an interchangeable lens. For example, there are such adapters as wide converters and teleconverters (extenders), adapters that convert a mount so as to enable mounting of a lens that has a different mount shape and cannot be mounted directly on a camera (mount conversion adapters), and so forth. In this case, command transmission from a camera to an interchangeable lens, and data transmission from an interchangeable lens to a camera, are performed via an adapter. Furthermore, there is a case where a camera obtains not only data of an interchangeable lens, but also information of an adapter mounted thereon, by communicating with the adapter. Therefore, a camera system may include a communication system intended for a camera to communicate with a plurality of accessories including an interchangeable lens and an adapter.

Japanese Patent Laid-Open No. 2019-3208 discloses a system that, in a case where an intermediate accessory like an adapter is mounted between a camera and an interchangeable lens, includes a channel for performing camera-lens communication and a channel for performing camera-adapter communication.

Also, Japanese Patent No. 6360261 discloses a lens system technique that, after an intermediate accessory has been recognized based on the polarity of a specific terminal, switches between camera-interchangeable lens data communication and interchangeable lens-intermediate accessory data communication in accordance with the polarity of the specific terminal.

In a case where an adapter is mounted between a camera (an image capturing apparatus) and an interchangeable lens, there is a possibility that an interchangeable lens mounted on the camera via the adapter does not support the specification of communication between a camera and an interchangeable lens that is for an interchangeable lens directly mountable on a camera, and supports a different specification of communication.

### SUMMARY

One or more aspects of embodiments of the present disclosure have been made in view of the aforementioned situation. The present disclosure provides a technique or techniques to enable one or more embodiments of an image capturing apparatus to communicate with one or more embodiments of an interchangeable lens in a situation where an interchangeable lens, which does not support the specification of communication between an image capturing apparatus and an interchangeable lens that is for an interchangeable lens directly mountable on an image capturing apparatus and which supports a different specification of communication, is mounted on the image capturing apparatus via an adapter.

According to at least a first aspect of the present disclosure, there is provided at least one embodiment of an image capturing apparatus, which may include: a first contact unit connectable to a first contact unit of an adapter; a second contact unit connectable to a second contact unit of the adapter; and at least one processor which functions as: a first communication unit that operates to perform a first communication via the first contact unit of the image capturing apparatus; a second communication unit that operates to perform a second communication via the second contact unit of the image capturing apparatus; a third communication unit that operates to perform a third communication via a predetermined contact unit that is the first contact unit or the second contact unit of the image capturing apparatus; and a control unit, wherein the adapter may include a communication path that can be switched between: (i) a first state where the third communication from the image capturing apparatus does not reach a third contact unit of the adapter, and (ii) a second state where the third communication reaches the third contact unit of the adapter, the third contact unit of the adapter is connectable to a third contact unit of an interchangeable lens, and the control unit of the image capturing apparatus operates to perform a control to: recognize the adapter via the first communication or the second communication while the communication path is in the first state, transmit a switching instruction instructing to switch the communication path to the second state via the first communication or the second communication after recognizing the adapter, and start the third communication after transmitting the switching instruction.

According to at least a second aspect of the present disclosure, there is provided at least one embodiment of an image capturing apparatus, which may include: a first contact unit; a second contact unit; and at least one processor which functions as: a first communication unit that operates to perform a first communication via the first contact unit; a second communication unit that operates to perform a second communication via the second contact unit; a third communication unit that operates to perform a third communication via a predetermined contact unit that is the first contact unit or the second contact unit of the image capturing apparatus; and a control unit, wherein the control unit operates to perform a control to: recognize a mounted adapter via the first communication or the second communication, transmit an instruction to the adapter after recognizing the adapter, and start the third communication after transmitting the instruction.

According to at least a third aspect of the present disclosure, there is provided at least one embodiment of an adapter, which may include: a first contact unit connectable to a first contact unit of an image capturing apparatus; a second contact unit connectable to a second contact unit of the image capturing apparatus; a third contact unit connectable to a third contact unit of an interchangeable lens; at least one processor which functions as at least one of: a first communication unit that operates to perform a first communication via the first contact unit of the adapter, and a second communication unit that operates to perform a second communication via the second contact unit of the adapter; and a communication path that operates to be switched between: (i) a first state where a third communication from the image capturing apparatus via a predetermined contact unit does not reach the third contact unit of the adapter, and (ii) a second state where the third communication reaches the third contact unit of the adapter, the predetermined contact unit being the first contact unit or the second contact unit of the adapter, wherein the at least one processor further functions as a control unit that operates to perform a control to switch the communication path to the second state in response to a reception of a switching instruction instructing to switch the communication path to the second state from the image capturing apparatus via the first communication or the second communication while the communication path is in the first state.

According to at least a fourth aspect of the present disclosure, there is provided at least one embodiment of an adapter, which may include: a first contact unit; a second contact unit; a third contact unit; at least one processor which functions as at least one of: a first communication unit that operates to perform a first communication via the first contact unit, and a second communication unit that operates to perform a second communication via the second contact unit; and a communication path that operates to be switched between: (i) a first state where a third communication via a predetermined contact unit does not reach the third contact unit, and (ii) a second state where the third communication reaches the third contact unit, the predetermined contact unit being the first contact unit or the second contact unit, wherein the at least one processor further functions as a control unit that operates to perform a control to switch the communication path to the second state in response to a reception of an instruction via the first communication or the second communication while the communication path is in the first state.

According to at least a fifth aspect of the present disclosure, there is provided at least one embodiment of a system that may include: the at least one embodiment of the image capturing apparatus according to the first aspect; and the at least one embodiment of the adapter according to the third aspect.

According to at least a sixth aspect of the present disclosure, there is provided at least one embodiment of a control method executed by an image capturing apparatus, wherein the image capturing apparatus may include: a first contact unit connectable to a first contact unit of an adapter; a second contact unit connectable to a second contact unit of the adapter; and at least one processor which functions as: a first communication unit that operates to perform a first communication via the first contact unit of the image capturing apparatus; a second communication unit that operates to perform a second communication via the second contact unit of the image capturing apparatus; and a third communication unit that operates to perform a third communication via a predetermined contact unit that is the first contact unit or the second contact unit of the image capturing apparatus, wherein the adapter includes a communication path that operates to be switched between: (i) a first state where the third communication from the image capturing apparatus does not reach a third contact unit of the adapter, and (ii) a second state where the third communication reaches the third contact unit of the adapter, and the third contact unit of the adapter is connectable to a third contact unit of an interchangeable lens, the control method including: performing a control to recognize the adapter via the first communication or the second communication while the communication path is in the first state; after recognizing the adapter, transmitting a switching instruction instructing to switch the communication path to the second state via the first communication or the second communication; and starting the third communication after transmitting the switching instruction.

According to at least a seventh aspect of the present disclosure, there is provided at least one embodiment of a control method executed by an adapter, wherein the adapter may include: a first contact unit connectable to a first contact unit of an image capturing apparatus; a second contact unit connectable to a second contact unit of the image capturing apparatus; a third contact unit connectable to a third contact unit of an interchangeable lens; at least one processor which functions as at least one of: a first communication unit that operates to perform a first communication via the first contact unit of the adapter, and a second communication unit that operates to perform a second communication via the second contact unit of the adapter; and a communication path that operates to be switched between: (i) a first state where third communication from the image capturing apparatus via a predetermined contact unit does not reach the third contact unit of the adapter, and (ii) a second state where the third communication reaches the third contact unit of the adapter, the predetermined contact unit being the first contact unit or the second contact unit of the adapter, the control method including: performing a control to switch the communication path to the second state in response to a reception of a switching instruction instructing to switch the communication path to the second state from the image capturing apparatus via the first communication or the second communication while the communication path is in the first state.

According to at least an eighth aspect of the present disclosure, there is provided at least one embodiment of an image capturing apparatus, which may include: a first contact unit connectable to a first contact unit of an adapter; a second contact unit connectable to a second contact unit of the adapter; a fourth contact unit connectable to a fourth contact unit of the adapter; and at least one processor which functions as: a first communication unit that operates to perform a first communication via the first contact unit of the image capturing apparatus; a second communication unit that operates to perform a second communication via the second contact unit of the image capturing apparatus; a third communication unit that operates to perform a third communication via the fourth contact unit of the image capturing apparatus; and a control unit, wherein the adapter may include a communication path that operates to cause the third communication from the image capturing apparatus to reach a third contact unit of the adapter, the third contact unit of the adapter is connectable to a third contact unit of an interchangeable lens, and the control unit of the image capturing apparatus operates to: perform a control to recognize the adapter via the first communication or the second communication, and start the third communication after recognizing the adapter.

According to at least a ninth aspect of the present disclosure, there is provided an adapter, which may include: a first contact unit connectable to a first contact unit of an image capturing apparatus; a second contact unit connectable to a second contact unit of the image capturing apparatus; a fourth contact unit connectable to a fourth contact unit of the image capturing apparatus; a third contact unit connectable to a third contact unit of an interchangeable lens; at least one processor which functions as at least one of: (i) a first communication unit that operates to perform a first communication via the first contact unit of the adapter, and (ii) a second communication unit that operates to perform a second communication via the second contact unit of the adapter; and a communication path that causes a third communication from the image capturing apparatus via the fourth contact unit of the adapter to reach the third contact unit of the adapter.

According to at least a tenth aspect of the present disclosure, there is provided an image capturing apparatus, which may include: a first contact unit; a second contact unit; a fourth contact unit; and at least one processor which functions as: a first communication unit that operates to perform a first communication via the first contact unit; a second communication unit that operates to perform a second communication via the second contact unit; a third communication unit that operates to perform a third communication via the fourth contact unit; and a control unit, wherein the control unit operates to: perform a control to recognize a mounted adapter via the first communication or the second communication, and start the third communication after recognizing the adapter.

According to at least an eleventh aspect of the present disclosure, there is provided at least one embodiment of an adapter, which may include: a first contact unit; a second contact unit; a fourth contact unit; a third contact unit; at least one processor which functions as at least one of: (i) a first communication unit that operates to perform a first communication via the first contact unit, and (ii) a second communication unit that operates to perform a second communication via the second contact unit; and a communication path that operates to cause a third communication via the fourth contact unit to reach the third contact unit.

According to at least a twelfth aspect of the present disclosure, there is provided at least one embodiment of a system which may include: the at least one embodiment of the image capturing apparatus according to the eighth aspect; and the at least one embodiment of the adapter according to the ninth aspect.

According to at least a thirteenth aspect of the present disclosure, there is provided at least one embodiment of a control method executed by an image capturing apparatus which may include: a first contact unit connectable to a first contact unit of an adapter; a second contact unit connectable to a second contact unit of the adapter; a fourth contact unit connectable to a fourth contact unit of the adapter; and at least one processor which functions as: a first communication unit that operates to perform a first communication via the first contact unit of the image capturing apparatus; a second communication unit that operates to perform a second communication via the second contact unit of the image capturing apparatus; and a third communication unit that operates to perform a third communication via the fourth contact unit of the image capturing apparatus, wherein the adapter may include a communication path that causes the third communication from the image capturing apparatus to reach a third contact unit of the adapter, the third contact unit of the adapter being connectable to a third contact unit of an interchangeable lens, the control method including: performing a control to recognize the adapter via the first communication or the second communication, and starting the third communication after recognizing the adapter.

According to other aspects of the present disclosure, one or more additional imaging capturing apparatuses, one or more additional adapters, one or more additional systems, one or more additional control methods, and one or more storage mediums are discussed herein. Further features of the present disclosure will become apparent from the following description of exemplary embodiments with reference to the attached drawings.

### BRIEF DESCRIPTION OF THE DRAWINGS

FIG. 1 is a block diagram showing a configuration of a camera system according to a first embodiment of the present disclosure.

FIG. 2A is a flowchart of at least one embodiment of a processing for starting a camera that may be used with the first embodiment to a third embodiment of the present disclosure.

FIG. 2B is a flowchart of at least one embodiment of a processing for starting an adapter that may be used with the first embodiment of the present disclosure.

FIG. 3 is a flowchart showing the details of at least one embodiment of a communication switching processing (step S254) that may be used with the first embodiment and the second embodiment of the present disclosure.

FIG. 4 is a block diagram showing a configuration of a camera system according to the second embodiment of the present disclosure.

FIG. 5 is a flowchart of at least one embodiment of a processing for starting an adapter that may be used with the second embodiment of the present disclosure.

FIG. 6 is a block diagram showing a configuration of a camera system according to the third embodiment of the present disclosure.

FIG. 7A is a flowchart of at least one embodiment of a processing for starting an adapter that may be used with the third embodiment of the present disclosure.

FIG. 7B is a flowchart showing the details of at least one embodiment of a communication switching processing (step S754) that may be used with the third embodiment of the present disclosure.

FIG. 8 is a block diagram showing a configuration of a camera system according to a fourth embodiment of the present disclosure.

FIG. 9A is a flowchart of at least one embodiment of a processing for starting a camera that may be used with the fourth embodiment and a fifth embodiment of the present disclosure.

FIG. 9B is a flowchart of at least one embodiment of a processing for starting an adapter that may be used with the fourth embodiment of the present disclosure.

FIG. 9C is a flowchart showing the details of at least one embodiment of a communication switching processing (step S954) that may be used with the fourth embodiment of the present disclosure.

FIG. 10 is a block diagram showing a configuration of a camera system according to the fifth embodiment of the present disclosure.

FIG. 11A is a flowchart of at least one embodiment of a processing for starting an adapter that may be used with the fifth embodiment of the present disclosure.

FIG. 11B is a flowchart showing the details of at least one embodiment of a communication switching processing (step S1154) that may be used with the fifth embodiment of the present disclosure.

FIG. 12 is a block diagram showing a configuration of a camera system according to a sixth embodiment of the present disclosure.

FIG. 13A is a flowchart of at least one embodiment of a processing for starting a camera that may be used with the sixth embodiment of the present disclosure.

FIG. 13B is a flowchart of at least one embodiment of a processing for starting an adapter that may be used with the sixth embodiment of the present disclosure.

### DESCRIPTION OF THE EMBODIMENTS

Hereinafter, one or more embodiments will be described in detail with reference to the attached drawings. Note, the following embodiments are not intended to limit the scope of the claimed one or more features of the present disclosure. Multiple features are described in the one or more embodiments, but limitation is not made to any of the one or more embodiments that require all such features, and multiple such features may be combined as appropriate. Furthermore, in the attached drawings, the same reference numerals are given to the same or similar configurations, and redundant description thereof is omitted.

### First Embodiment

### <Configuration of at Least One Embodiment of a Camera System>

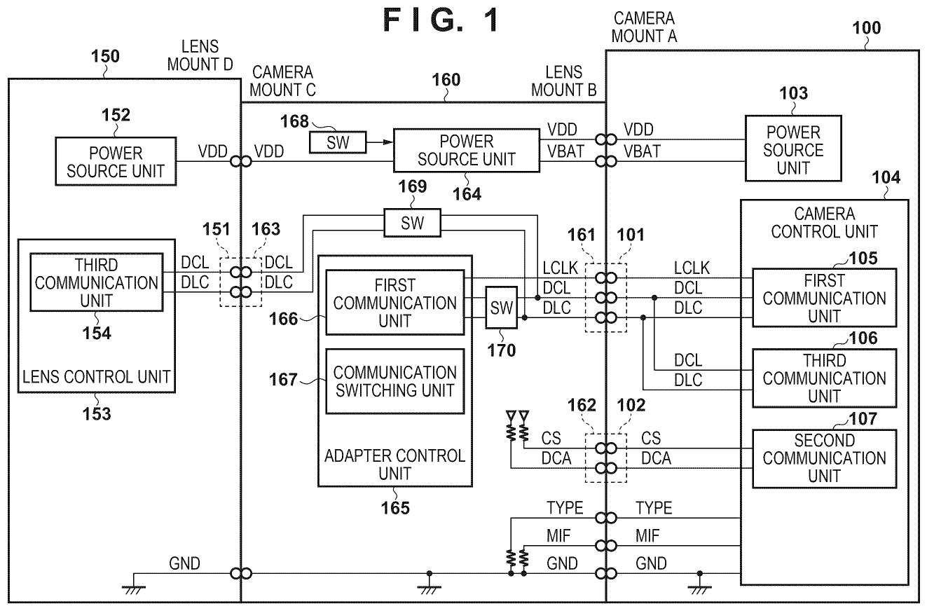

FIG. 1 is a block diagram showing a configuration of a camera system according to a first embodiment. The camera system includes a camera 100 (an image capturing apparatus), an interchangeable lens 150 (an interchangeable lens apparatus), and an adapter 160 (an adapter apparatus) arranged between the camera and the interchangeable lens 150.

The camera 100 includes a camera mount A. The adapter 160 includes a lens mount B connectable to the camera mount A. Therefore, the adapter 160 may be mounted directly on the camera 100.

Also, the adapter 160 includes a camera mount C, which is different from the camera mount A, at the opposite side of the lens mount B. The interchangeable lens 150 includes a lens mount D connectable to the camera mount C. Therefore, the interchangeable lens 150 may be mounted directly on the adapter 160.

Unlike the lens mount B, the lens mount D of the interchangeable lens 150 is shaped in such a manner that it cannot be connected to the camera mount A of the camera 100. Therefore, the interchangeable lens 150 cannot be mounted directly on the camera 100, but may be mounted on the camera 100 via the adapter 160. Note that an interchangeable lens including the lens mount B (not shown) may be mounted directly on the camera 100.

### <Functions of Terminals of Camera Mount A and Lens Mount B>

Next, the functions of each terminal common to both of the camera mount A and the lens mount B will be described.

A VDD terminal is a terminal for supplying power from the camera 100 to a camera accessory mounted on the camera 100, mainly as communication power used in communication control. A camera accessory (which may hereinafter be simply referred to as an “accessory”) is a general term for an apparatus, such as an adapter and an interchangeable lens, connectable to a camera mount like the camera mount A, the camera mount C, or the like. For example, the adapter 160 including the lens mount B, an interchangeable lens including the lens mount B (not shown), the interchangeable lens 150 including the lens mount D, and the like are equivalent to a camera accessory.

Note that, hereinafter, the “VDD terminal” may be simply referred to as “VDD” by omitting the notation of “terminal”. In this regard, the same goes for terminals other than the VDD terminal; for example, a later-described “VBAT terminal” may be simply referred to as “VBAT”.

A VBAT terminal is a terminal for supplying power from the camera 100 to a camera accessory, mainly as driving power used in driving of actuators for a diaphragm, a focus lens, and the like. In the present embodiment, it is assumed that a voltage supplied from the camera 100 is 4.7 V. Note that it is permissible to adopt a configuration in which the voltage supplied to the VBAT terminal is changeable in accordance with a type of an accessory mounted on the camera 100.

A GND terminal is a ground terminal indicating a ground level corresponding to various types of terminals including the VDD terminal.

An MIF terminal is a terminal for detecting mounting of a camera accessory (e.g., the adapter 160, an interchangeable lens including the lens mount B (not shown), or the like) on the camera 100. The camera 100 detects mounting of a camera accessory on the camera 100 and detachment of a camera accessory therefrom by detecting a voltage level of the MIF terminal. In the present embodiment, the camera 100 determines that an accessory is not mounted in a case where the voltage of the MIF terminal is High (H), and determines that an accessory is mounted in a case where this voltage is Low (L).

A TYPE terminal is a terminal for distinguishing a type of a camera accessory mounted on the camera 100. The camera 100 detects a voltage of the TYPE terminal, and distinguishes the accessory to be an interchangeable lens including the lens mount B (not shown) in a case where the voltage falls in a predetermined range 1. Also, the camera 100 distinguishes the accessory to be an adapter including the lens mount B in a case where the voltage falls in a predetermined range 2. Furthermore, the camera 100 distinguishes an occurrence of an error in a case where the voltage falls in neither the predetermined range 1 nor the predetermined range 2. The TYPE terminal of the interchangeable lens including the lens mount B (not shown) is pulled-down and connected to the GND terminal via a resistor so that the voltage falls in the predetermined range 1. The TYPE terminal of the adapter 160 is pulled down and connected to the GND terminal via a resistor so that the voltage falls in the predetermined range 2. Note that as a distinction of a type of a camera accessory using the TYPE terminal is made based on the detected voltage of the TYPE terminal, it is necessary to set voltage ranges corresponding to respective camera accessories in order to allow a large variety of camera accessories to be distinguished. For this reason, for example, in order to make a more detailed distinction as to which model the interchangeable lens including the lens mount B has, and which model the adapter has, it is favorable to use a distinction method different from the method that uses the TYPE terminal.

An LCLK terminal is a terminal for a clock signal output from the camera 100 to a camera accessory. Furthermore, the LCLK terminal also plays a role as a terminal intended for the camera 100 to monitor a busy state of an accessory.

A DCL terminal is a terminal for communication data output from the camera 100 to a camera accessory.

A DLC terminal is a terminal for communication data output from a camera accessory to the camera 100.

A CS terminal is a signal terminal for a request for communication between the camera 100 and a camera accessory.

A DCA terminal is a terminal for communication data for performing bidirectional communication between the camera 100 and a camera accessory.

In the present embodiment, the LCLK terminal, the DCL terminal, and the DLC terminal are used in later-described first communication. Also, the DCL terminal and the DLC terminal are used in later-described third communication as well, in addition to the first communication. Furthermore, the CS terminal and the DCA terminal are used in later-described second communication.

Note that the camera mount A and the lens mount B may include a PGND terminal and a DLC2 terminal (neither of them are shown). The PGND terminal is a ground terminal corresponding to the VBAT terminal. The DLC2 terminal is a terminal for data communication from a camera accessory to the camera 100, and this data communication is communication different from and independent of the first communication, the second communication, and the third communication.

As described above, the camera mount A and the lens mount B include ten or more terminals. Note that although the terminals of the camera mount A are contact pins and the terminals of the lens mount B are contact surfaces, it is permissible to adopt a configuration in which their shapes are reversed.

### <Functions of Terminals of Camera Mount C and Lens Mount D>

Next, the functions of each terminal common to both of the camera mount C and the lens mount D will be described.

A VDD terminal is a terminal that supplies power from the camera 100 as power used in control on the interchangeable lens 150. In the present embodiment, it is assumed that a voltage supplied to the camera mount C and the lens mount D is 11.0 V.

A GND terminal is a ground terminal indicating a ground level corresponding to the VDD terminal.

A DCL terminal is a terminal for communication data output from the camera 100 to the interchangeable lens 150.

A DLC terminal is a terminal for communication data output from the interchangeable lens 150 to the camera 100.

In the present embodiment, the DCL terminal and the DLC terminal are used in the later-described third communication.

As described above, the camera mount C and the lens mount D include four terminals. Note that although the terminals of the camera mount C are contact pins and the terminals of the lens mount D are contact surfaces, it is permissible to adopt a configuration in which their shapes are reversed.

### <Configuration of Camera 100>

Next, a configuration of the camera 100 will be described. The camera 100 includes the terminals of the camera mount A, and includes a contact unit 101, a contact unit 102, a power source unit 103, and a camera control unit 104. A first communication unit 105, a third communication unit 106, and a second communication unit 107 are provided inside the camera control unit 104.

The contact unit 101 (a first contact unit) is a group of contacts for performing communication controlled by the first communication unit 105 or the third communication unit 106, and is composed of three terminals, namely LCLK, DCL, and DLC.

The contact unit 102 (a second contact unit) is a group of contacts for performing communication controlled by the second communication unit 107, and is composed of two terminals, namely CS and DCA.

The power source unit 103 generates power to be supplied to a camera accessory mounted on the camera 100 via VDD or VBAT. Furthermore, the power source unit 103 also generates power to be supplied to the inside of the camera 100, such as the camera control unit 104.

The camera control unit 104 plays a role in control in the camera 100; for example, it calculates a focus lens driving amount for focus control, generates image data in accordance with a state of a release switch, and so forth. Note that the camera control unit 104 is composed of one or more processors or a circuit (e.g., an ASIC) that realizes one or more functions, and each unit can be controlled by, for example, the processor(s) reading out and executing a program stored in a memory.

The first communication unit 105 performs camera-lens communication (hereinafter referred to as “first communication”) for transmitting a command for an instruction or a request to an interchangeable lens including the lens mount B (not shown), and receiving lens information from the interchangeable lens. As shown in FIG. 1, the first communication unit 105 performs communication using three communication lines corresponding to LCLK, DCL, and DLC in the contact unit 101. It is assumed that a communication voltage of the first communication unit 105 in the present embodiment is 5.0 V. The first communication can be performed through, for example, clock synchronous communication or asynchronous communication; however, in the present embodiment, it is assumed that the first communication is performed through clock synchronous communication. Also, in the present embodiment, the camera 100 is configured so that, in a case where an accessory has been detected using the MIF terminal and the TYPE terminal, communication is performed with the camera accessory using the first communication unit 105 at first.

The third communication unit 106 is a communication unit for performing communication with the interchangeable lens 150 including the lens mount D. The third communication unit 106 performs camera-lens communication (hereinafter referred to as “third communication”) for transmitting a command for an instruction or a request to the interchangeable lens 150, and receiving lens information from the interchangeable lens 150. The third communication is a communication standard capable of communicating with an interchangeable lens that does not support the first communication and the second communication. As shown in FIG. 1, the third communication unit 106 performs communication using two communication lines corresponding to DCL and DLC in the contact unit 101. Also, the third communication unit 106 performs asynchronous communication of a standard different from the communication standard of the first communication unit 105. In the present embodiment, DCL and DLC, which are two terminals in the contact unit 101 used by the first communication unit 105, are also used by the third communication unit 106.

Note that in the present specification, in a case where at least a part of terminals inside the contact unit 101 (first contact unit) is used, such expressions as “the contact unit 101 is used” and “via the contact unit 101” are used. Therefore, both of the first communication that uses three terminals of the contact unit 101, and the third communication that uses two terminals of the contact unit 101, are communication in which the contact unit 101 is used (or communication performed via the contact unit 101). In this regard, the same goes for contact units other than the contact unit 101.

The second communication unit 107 is a communication unit for performing communication with an accessory (an intermediate accessory) arranged between the camera and the interchangeable lens, such as the adapter 160. The second communication unit 107 performs camera-adapter communication (hereinafter referred to as “second communication”) for transmitting a command to the adapter 160, and receiving data indicating a state of the intermediate accessory. As shown in FIG. 1, the second communication unit 107 performs communication using two communication lines corresponding to CS and DCA in the contact unit 102. It is assumed that a communication voltage of the second communication unit 107 in the present embodiment is 3.0 V. A communication channel of the second communication unit 107 is a communication channel different from and independent of the first communication unit 105 and the third communication unit 106. As the second communication is communication between the camera and the adapter, in a case where the adapter is not mounted on the camera 100, a response is not returned even if the second communication unit 107 has transmitted a command for the second communication. Therefore, if a response is not returned for a predetermined time period after an authentication command has been transmitted in the second communication, the camera control unit 104 determines that an adapter supporting the second communication is not mounted.

### <Configuration of Interchangeable Lens 150>

Next, a configuration of the interchangeable lens 150 will be described. The interchangeable lens 150 has the lens mount D, and includes a contact unit 151, a power source unit 152, and a lens control unit 153. A third communication unit 154 is provided inside the lens control unit 153.

The contact unit 151 (a third contact unit) is a group of contacts for the third communication with the camera 100, and is composed of two terminals, namely DCL and DLC.

The power source unit 152 supplies a voltage supplied from the camera 100 via the VDD terminal to, for example, the lens control unit 153 inside the interchangeable lens 150. In the present embodiment, a voltage of 9V to 35V is required as a voltage of the interchangeable lens 150.

The lens control unit 153 plays a role in control in the interchangeable lens 150; for example, it obtains position information of the focus lens (not shown) and information of the diaphragm. Note that the lens control unit 153 is composed of one or more processors or a circuit (e.g., an ASIC) that realizes one or more functions, and each unit can be controlled by, for example, the processor(s) reading out and executing a program stored in a memory.

The third communication unit 154 is a communication unit for performing the third communication with the third communication unit 106 of the camera 100. The third communication unit 154 receives a command from the camera 100, and transmits information of the interchangeable lens 150. As shown in FIG. 1, the third communication unit 154 performs communication using two communication lines corresponding to DCL and DLC in the contact unit 151.

### <Configuration of Adapter 160>

Next, a configuration of the adapter 160 will be described. The adapter 160 has the lens mount B and the camera mount C, and is provided with a contact unit 161, a contact unit 162, a contact unit 163, a power source unit 164, an adapter control unit 165, a switch 168, a switch 169, and a switch 170. The switches may be denoted by “SW”. A first communication unit 166 and a communication switching unit 167 are provided inside the adapter control unit 165.

The contact unit 161 (a first contact unit) is a group of contacts for the first communication with the camera 100, and is composed of three terminals, namely LCLK, DCL, and DLC. Furthermore, the contact unit 161 is also used for the third communication between the camera 100 and the interchangeable lens 150. The contact unit 161 of the adapter 160 is connectable to the contact unit 101 of the camera 100.

The contact unit 162 (a second contact unit) is a group of contacts for the second communication with the camera 100, and is composed of two terminals, namely CS and DCA. Note that in the present embodiment, CS and DCA of the contact unit 162 are not connected to the adapter control unit 165, and pull-up and connected to a power source (VDD). Therefore, even if the second communication unit 107 of the camera control unit 104 has transmitted a command (a second command) via the second communication, no response is transmitted from the adapter 160. The contact unit 162 of the adapter 160 is connectable to the contact unit 102 of the camera 100.

The contact unit 163 (a third contact unit) is a group of contacts for the third communication between the camera 100 and the interchangeable lens 150, and is composed of two terminals, namely DCL and DLC. The contact unit 163 of the adapter 160 is connectable to the contact unit 151 of the interchangeable lens 150.

The power source unit 164 supplies power supplied from the camera 100 via VDD and VBAT to, for example, the adapter control unit 165 inside the adapter 160. Also, in the present embodiment, in a case where the switch 168 has been set to be active, the power source unit 164 increases the voltage of power of VBAT supplied from the camera 100 to a voltage to be supplied to the interchangeable lens 150 including the lens mount D.

The adapter control unit 165 plays a role in control in the adapter 160. The adapter control unit 165 performs control on the switches 168, 169, and 170. Note that the adapter control unit 165 is composed of one or more processors or a circuit (e.g., an ASIC) that realizes one or more functions, and each unit can be controlled by, for example, the processor(s) reading out and executing a program stored in a memory.

The first communication unit 166 is a communication unit for performing the first communication with the first communication unit 105 of the camera 100. As the first communication is camera-lens communication, it can be said that the first communication bears no direct relationship to control of the adapter 160. However, an interchangeable lens including the lens mount B (an interchangeable lens capable of responding to the first communication from the camera 100) cannot be mounted on the adapter 160, and furthermore, the interchangeable lens 150 cannot respond to the first communication from the camera 100. In view of this, in the present embodiment, the adapter 160 is configured to include the first communication unit 166 so that the adapter 160 can respond to the first communication from the camera 100. The first communication unit 166 responds to a command (a first command) transmitted from the first communication unit 105 inside the camera 100 via the first communication.

The communication switching unit 167 switches between the first communication and the third communication by controlling the switch 168, the switch 169, and the switch 170. Specifically, the communication switching unit 167 controls the switch 168 to make the switch as to whether the power that has been increased in voltage by the power source unit 164 is to be supplied to the VDD terminal of the camera mount C. Also, the communication switching unit 167 controls the switches 169 and 170 to make the switch as to whether DCL and DLC of the contact unit 161 are to be connected to the first communication unit 166 (in this case, connection to the contact unit 163 is cut off) or connected to the contact unit 163 (in this case, connection to the first communication unit 166 is cut off).

The switch 168 is controlled by the communication switching unit 167. When the switch 168 has been set to be active, the power source unit 164 increases the voltage of power supplied from the VBAT terminal, and supplies the power that has been increased in voltage to the VDD terminal of the camera mount C. When the switch 168 has been set to be inactive, the power source unit 164 neither increases the voltage, nor supplies power to the VDD terminal of the camera mount C. In the present embodiment, the switch 168 is in an inactive state at the time of start-up of the adapter 160.

The switch 169 is controlled by the communication switching unit 167. When the switch 169 has been set to be active, DCL and DLC of the contact unit 161 are connected to the contact unit 163. When the switch 169 has been set to be inactive, connection between DCL and DLC of the contact unit 161 and the contact unit 163 is broken. In the present embodiment, the switch 169 is in an inactive state at the time of start-up of the adapter 160.

The switch 170 is controlled by the communication switching unit 167. When the switch 170 has been set to be active, DCL and DLC of the contact unit 161 are connected to the first communication unit 166. When the switch 170 has been set to be inactive, connection between DCL and DLC of the contact unit 161 and the first communication unit 166 is broken. In the present embodiment, the switch 170 is in an active state at the time of start-up of the adapter 160.

As described above, the adapter 160 includes a communication path that can be switched between a state where the third communication from the camera 100 via the contact unit 101 and the contact unit 161 does not reach the contact unit 163 (a first state) and a state where the third communication reaches the contact unit 163 (a second state). Switching of the state of the communication path is controlled by the communication switching unit 167. In a case where the communication path is in a state where the third communication reaches the contact unit 163 (the second state), the third communication reaches the third communication unit 154 from the contact unit 163 via the contact unit 151, and consequently, the camera 100 can perform the third communication with the interchangeable lens 150.

### <Processing for Starting Camera 100>

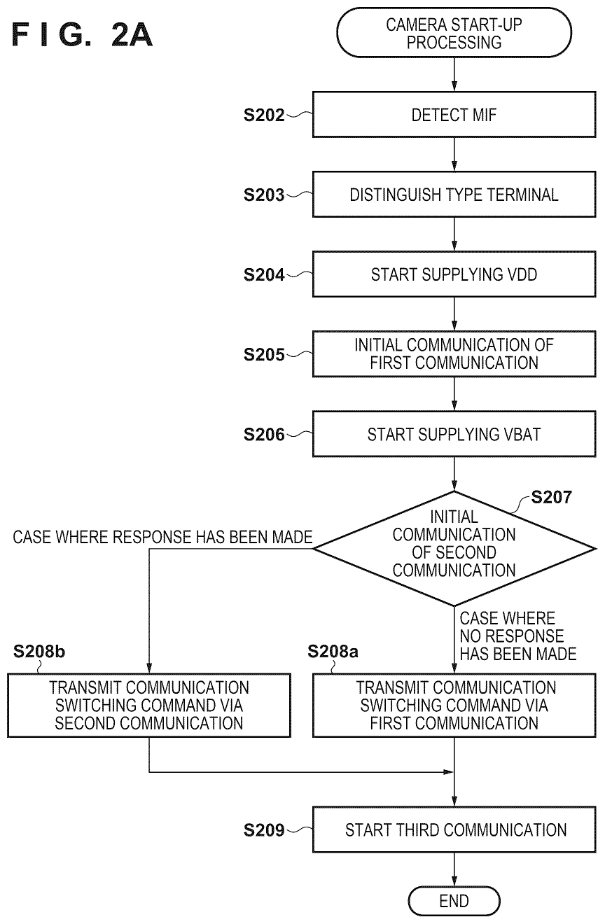

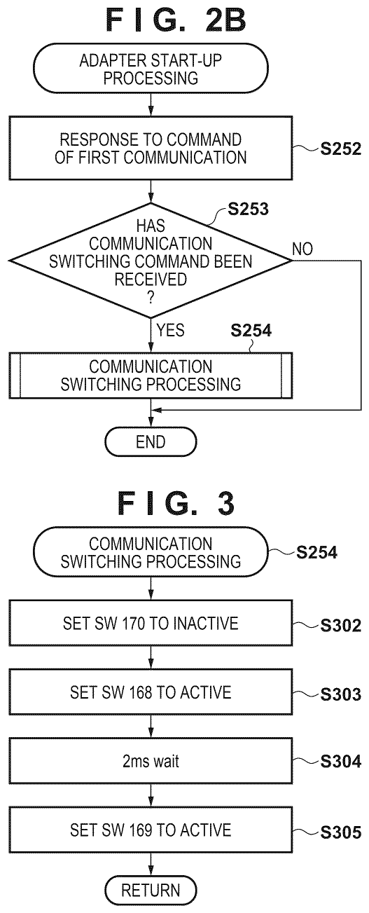

FIG. 2A is a flowchart of processing for starting the camera 100. When a user has operated a power source button (not shown) of the camera 100, a power source of the camera 100 is turned ON, and the power source unit 103 starts to supply an operating power; consequently, the camera control unit 104 starts the start-up processing of the present flowchart. It is assumed that processing of each step in the present flowchart is realized by the camera control unit 104 executing a program stored in a ROM (not shown) unless specifically stated otherwise.

In step S202, the camera control unit 104 detects the MIF terminal. In a case where the voltage of the MIF terminal is H, the camera control unit 104 determines that a camera accessory including the lens mount B is not mounted, and continues the detection of the MIF terminal in step S202 until the MIF terminal becomes L. In a case where the voltage of the MIF terminal is L, the camera control unit 104 determines that an accessory including the lens mount B has been mounted, and processing proceeds to step S203.

In step S203, the camera control unit 104 distinguishes the TYPE terminal. The camera control unit 104 distinguishes the type of the camera accessory in accordance with a voltage level of the TYPE terminal. In a case where the voltage of the TYPE terminal falls in the predetermined range 1, the camera control unit 104 distinguishes the type of the accessory to be an interchangeable lens, and sets the voltage of the first communication at 3.0 V. In a case where the voltage of the TYPE terminal falls in the predetermined range 2, the camera control unit 104 distinguishes the type of the accessory to be an adapter, and sets the voltage of the first communication at 5.0 V. It is assumed here that the adapter 160 has been mounted.

Note that although the camera control unit 104 has distinguished the type of the mounted accessory to be the adapter at this point, it has not recognized a model, a specific configuration, and the like of the mounted adapter. In other words, the camera control unit 104 has not recognized that the mounted adapter is the adapter 160.

In step S204, the camera control unit 104 starts to supply a VDD voltage to the accessory. In the present embodiment, 5.0 V is supplied.

In step S205, the first communication unit 105 inside the camera control unit 104 performs initial communication of the first communication. Specifically, the first communication unit 105 starts clock synchronous communication of the first communication with the first communication unit 166 inside the adapter control unit 165. At this time, the switches 168, 169, and 170 are under settings corresponding to the time of adapter start-up. Therefore, DCL and DLC of the contact units 101 and 161 are connected to the first communication unit 166, and disconnected from the contact unit 163.

A communication method of the first communication unit 105 is a communication method intended for communication with an interchangeable lens including the lens mount B. In the present embodiment, the adapter 160 is mounted on the camera 100 instead of an interchangeable lens including the lens mount B, and the interchangeable lens 150 that does not support the first communication is mounted on the adapter 160. However, the specification of the startup processing sequence for the camera 100 is configured to, in a case where an accessory has been detected using the MIF terminal, recognize an interchangeable lens including the lens mount B via the first communication at first. In view of this, in the present embodiment, the adapter 160 including the lens mount B is configured to be capable of executing the first communication intended for an interchangeable lens, similarly to an interchangeable lens including the lens mount B.

The first communication unit 105 transmits, for example, a command for checking communication with the lens mount B, a command for obtaining a lens ID (a command for distinguishing the mounted accessory), and a command for obtaining a focal length, an F-number, and the like. The first communication unit 166 responds to a command transmitted from the first communication unit 105 in such a manner that it behaves as an interchangeable lens including the lens mount B. That is to say, although the adapter 160 does not actually have a focal length, an F-number, and the like as it is not an interchangeable lens, the first communication unit 166 transmits dummy fixed values related to a focal length, an F-number, and the like (e.g., a focal length of 50 mm, an F-number of F16, and the like) in addition to a lens ID.

The camera control unit 104 distinguishes the type of the mounted accessory by obtaining initial information, such as the lens ID, via the first communication. If the information of the lens ID and the like is known to the camera control unit 104 (i.e., if the mounted accessory is recognizable to the camera control unit 104), the camera control unit 104 recognizes the accessory. If the mounted accessory is not recognizable to the camera control unit 104 (e.g., in a case where the accessory was released for sale after the camera 100 was released for sale), the camera control unit 104 recognizes the mounted accessory as an “unknown accessory”. Even in a case where the mounted accessory has been recognized as an “unknown accessory”, the first communication unit 105 transmits a command for obtaining a focal length, an F-number, and the like.

In the present embodiment, a specific lens ID (e.g., a lens ID of “ABCD”) has been assigned to the adapter 160. Therefore, based on the obtained lens ID, the camera control unit 104 can recognize the mounted accessory including the lens mount B as the adapter 160 that performs conversion from the lens mount B to the lens mount D. Alternatively, rather than performing the recognition with use of the specific lens ID, the camera control unit 104 may obtain flag information indicating whether the mounted accessory has a function of performing conversion from the lens mount B to the lens mount D. Then, in a case where this flag has been set, the camera control unit 104 may recognize the mounted accessory as the adapter 160 that performs conversion from the lens mount B to the lens mount D. In this way, the camera control unit 104 can transmit a command (a first command) via the first communication, and recognize the adapter 160 on the basis of a response to this command.

Note that although the adapter 160 is an adapter of a type including the lens mount B and the camera mount C (hereinafter referred to as a “B-C adapter”), adapters that can be mounted on the camera 100 also include an adapter of a type including the lens mount B and the camera mount A (hereinafter referred to as a “B-A adapter”). Inside the B-A adapter, LCLK, DCL, and DLC in the lens mount B are connected to LCLK, DCL, and DLC in the camera mount A. An interchangeable lens including the lens mount B can be mounted on the camera mount A of the B-A adapter. Therefore, an interchangeable lens that includes the lens mount B and supports the first communication can be mounted on the camera 100 via the B-A adapter. In this case, in step S205, the first communication unit 105 of the camera 100 can recognize the interchangeable lens mounted via the B-A adapter by communicating with the first communication unit (not shown) of the interchangeable lens. Therefore, the specification of the start-up processing sequence for the camera 100 can support both of the adapter 160 (B-C adapter) on which the interchangeable lens 150 is mounted, and the B-A adapter on which the interchangeable lens including the lens mount B is mounted.

In step S206, the camera control unit 104 performs control to start a supply of a VBAT voltage.

In step S207, the second communication unit 107 transmits a command for performing initial communication for adapter authentication and the like via the second communication.

A communication method of the second communication unit 107 is a communication method intended for communication with an adapter including the lens mount B. The specification of the start-up processing sequence for the camera 100 is configured to, after an interchangeable lens including the lens mount B is recognized via the first communication at first, perform initial communication via the second communication in order to check whether an adapter including the lens mount B is mounted. In the present embodiment, CS and DCA of the contact unit 162 in the adapter 160 are pulled up to the power source. Therefore, even if the second communication unit 107 has transmitted a command, no response is returned. In this case, the second communication unit 107 determines that no adapter is mounted, and thereafter does not perform command transmission via the second communication. In this case, processing proceeds from step S207 to step S208a.

On the other hand, in a case where a response has been made to a command (a second command) transmitted by the second communication unit 107 via the second communication, the second communication unit 107 authenticates the adapter by continuing the second communication, and thereafter, processing proceeds from step S207 to step S208b. This case will be described in a second embodiment.

In step S208a, in order to enable the camera 100 and the interchangeable lens 150 to communicate with each other, the first communication unit 105 transmits, via the first communication, a communication switching command for switching from the first communication to the third communication (which may hereinafter be referred to as a “communication switching instruction” or a “switching instruction”). In the present embodiment, although no response has been made to the command in step S207 and the camera 100 and the adapter 160 have not communicated with each other via the second communication, the camera control unit 104 has already recognized the adapter 160 through processing of step S205. Therefore, in step S208a, the first communication unit 105 inside the camera control unit 104 can transmit the communication switching command for the adapter 160.

In step S209 (after the communication switching command has been transmitted), the third communication unit 106 starts the third communication for communicating with the interchangeable lens 150 including the lens mount D. In the present embodiment, after the third communication has been started, the first communication unit 105 stops operating so as not to perform communication.

### <Processing for Starting Adapter 160>

FIG. 2B is a flowchart of processing for starting the adapter 160. When the adapter 160 has been mounted on the camera 100 and the power source unit 103 has started to supply power to the power source unit 164 via VDD (see step S204 of FIG. 2A), the adapter control unit 165 starts the start-up processing of the present flowchart. It is assumed that processing of each step in the present flowchart is realized by the adapter control unit 165 executing a program stored in a ROM (not shown) unless specifically stated otherwise.

In step S252, the first communication unit 166 responds to a command for the first communication that has been transmitted by the first communication unit 105 in step S205. The details of the response are as described in step S205.

In step S253, the first communication unit 166 determines whether a communication switching command transmitted by the first communication unit 105 in step S208a has been received. In a case where the communication switching command has been received within a predetermined time period since the start of processing of step S253, processing proceeds to step S254. In a case where the communication switching command has not been received within the predetermined time period since the start of processing of step S253 (i.e., on the occurrence of a timeout without reception of the communication switching command), processing of the present flowchart is terminated.

In step S254, the communication switching unit 167 executes communication switching processing. FIG. 3 is a flowchart showing the details of the communication switching processing in step S254.

In step S302, the communication switching unit 167 performs port control on the adapter control unit 165 so that the switch 170, which is currently active, becomes inactive. Once the switch 170 has become inactive, connection between DCL and DLC of the contact unit 161 and the first communication unit 166 is cut off, and the first communication transmitted from the first communication unit 105 of the camera control unit 104 no longer reaches the first communication unit 166 of the adapter control unit 165. Note that the first communication unit 166 may execute processing for stopping a synchronous communication function after the switch 170 has become inactive.

In step S303, the communication switching unit 167 performs port control on the adapter control unit 165 so that the switch 168, which is currently inactive, becomes active. Once the switch 168 has become active, power that has been increased in voltage by the power source unit 164 is supplied to VDD of the camera mount C. As a result, a supply of the power to the interchangeable lens 150 is started via VDD of the lens mount D.

In step S304, the communication switching unit 167 waits for 2 milliseconds (ms). This is because, while the power source unit 164 starts to increase the voltage from 4.7 V to 11.0 V after the switch 168 has become active in step S303, it takes approximately 2 ms to increase the voltage to a desired voltage. After 2 ms has elapsed, processing proceeds to step S305.

In step S305, the communication switching unit 167 performs port control on the adapter control unit 165 so that the switch 169, which is currently inactive, becomes active. Once the switch 169 has become active, DCL and DLC of the contact unit 161 become connected to DCL and DLC of the contact unit 163. This enables the third communication transmitted from the third communication unit 106 of the camera control unit 104 to reach the third communication unit 154 of the lens control unit 153, thereby enabling the camera 100 and the interchangeable lens 150 to exchange commands between each other via the third communication.

Thereafter, processing returns to the flowchart of FIG. 2B, and the processing for starting the adapter is completed.

### Summary of First Embodiment

As described above, according to the first embodiment, the camera system includes the camera 100 that supports the first communication, second communication, and third communication, the adapter 160 that supports the first communication, and the interchangeable lens 150 that supports the third communication. The specification of the start-up processing sequence for the camera 100 is configured to, in a case where an accessory has been detected, perform initial communication of the first communication at first, and then perform initial communication of the second communication. The interchangeable lens 150 including the lens mount D does not support the first communication, unlike an interchangeable lens including the lens mount B. However, as the adapter 160 supports the first communication, the camera 100 can receive a response to a command for the initial communication of the first communication, and recognize the adapter 160 on the basis of the response. After the adapter 160 has been recognized, the camera 100 transmits a communication switching command (a switching instruction) via the first communication. The adapter 160 switches the state of the communication path inside the adapter 160 so that the third communication from the camera 100 via DCL and DLC of the contact unit 101 reaches DCL and DLC of the contact unit 163.

Therefore, the present embodiment enables the camera 100 to communicate with the interchangeable lens 150 in a situation where the interchangeable lens 150, does not support the specification of camera-lens communication (the first communication) for an interchangeable lens including the lens mount B (an interchangeable lens directly mountable on the camera 100) and which supports a different specification of communication (the third communication), is mounted on the camera 100 via the adapter 160. Furthermore, as the camera 100 can recognize the adapter 160 via the first communication with the adapter 160, startup processing for the camera 100 can be executed in accordance with the same start-up processing sequence (a sequence in which the initial communication of the first communication is performed at first, and then the initial communication of the second communication is performed, in a case where an accessory has been detected), regardless of whether the interchangeable lens mounted on the camera 100 supports the specification of the first communication. Note that as the present embodiment is characterized in that a communication switching command is transmitted via the first communication in a case where no response has been made in the initial communication of the second communication in step S207 of the flowchart shown in FIG. 2A, the camera 100 need not transmit the communication switching command via the second communication in a case where a response has been made. For example, as the camera 100 has been able to recognize the adapter 160 via the first communication, it may transmit the communication switching command via the first communication after a predetermined time period has elapsed since the initial communication of the second communication was performed, regardless of whether a response has been made in the initial communication of the second communication. Alternatively, as the adapter 160 is not intended to have a function of performing the second communication, in a case where a response has been made in the initial communication of the second communication, the camera 100 may determine that a communication error has occurred, and notify the user of the occurrence of the communication error without transmitting the communication switching command.

### Second Embodiment

### <Configuration of at Least One Embodiment of a Camera System>

The first embodiment has been described in relation to the camera system including the adapter 160 that does not have a function of performing the second communication. In contrast, a second embodiment will be described in relation to a camera system including an adapter that has a function of performing the second communication. Note that in the description of the second embodiment, reference signs that are the same as those of the first embodiment are assigned to the configurations and processing that are the same as or similar to those of the first embodiment. The following mainly describes the differences from the first embodiment.

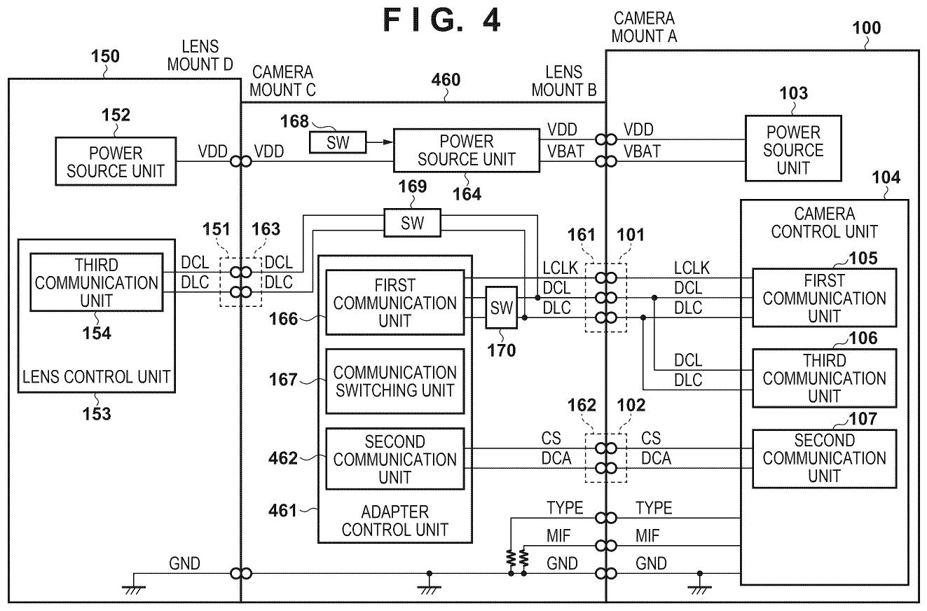

FIG. 4 is a block diagram showing a configuration of a camera system according to the second embodiment. The camera system of FIG. 4 is different from the camera system of the first embodiment (FIG. 1) in that it includes an adapter 460 in place of the adapter 160.

The adapter 460 includes an adapter control unit 461. A first communication unit 166, a communication switching unit 167, and a second communication unit 462 are provided inside the adapter control unit 461. Note that the adapter control unit 461 is composed of one or more processors or a circuit (e.g., an ASIC) that realizes one or more functions, and each unit can be controlled by, for example, the processor(s) reading out and executing a program stored in a memory. In the adapter 160 of the first embodiment, the CS terminal and the DCA terminal of the contact unit 162 are pulled up to the power source; meanwhile, in the adapter 460 of the second embodiment, the CS terminal and the DCA terminal of the contact unit 162 are connected to the second communication unit 462 of the adapter control unit 461.

The second communication unit 462 receives a second communication command from the second communication unit 107 of the camera control unit 104 via the contact units 102 and 162, and transmits a response. Therefore, in the present embodiment, the camera control unit 104 can recognize the adapter 460 on the basis of the response from the second communication unit 462. Furthermore, although a communication switching command for switching from the first communication to the third communication is transmitted via the first communication in the first embodiment, the communication switching command is transmitted via the second communication in the present embodiment.

### <Processing for Starting Camera 100>

Next, processing for starting the camera 100 will be described with reference to FIG. 2A. The processing for starting the camera 100 is executed in accordance with the flowchart of FIG. 2A, similarly to the first embodiment. However, unlike the first embodiment, the second communication unit 107 receives a response from the second communication unit 462 after transmitting a command via the second communication in step S207. Therefore, the second communication unit 107 continues the second communication, and starts an authentication sequence for adapter authentication. The authentication sequence of the second communication is performed by transmitting an authentication start notification, an authentication request, an authentication termination notification, and the like with use of broadcast communication and P2P communication. During this sequence, the second communication unit 107 obtains an adapter ID, obtains the functions that the adapter has, and obtains an adapter version, for example. In the present embodiment, the camera control unit 104 recognizes the mounted adapter as the adapter 460 that performs conversion from the lens mount B to the lens mount D through processing of step S207. Upon termination of the initial communication in the second communication, processing proceeds from step S207 to step S208b.

In step S208b, the second communication unit 107 transmits, via the second communication, a communication switching command for switching from the first communication to the third communication. Thereafter, processing proceeds to step S209, and the third communication is started, similarly to the first embodiment.

Note that in the present embodiment, too, the camera control unit 104 may cause processing to proceed from step S207 to step S208a, similarly to the first embodiment. That is to say, the present embodiment, too, may adopt a configuration in which the first communication unit 105 transmits the communication switching command via the first communication.

### <Processing for Starting Adapter 460>

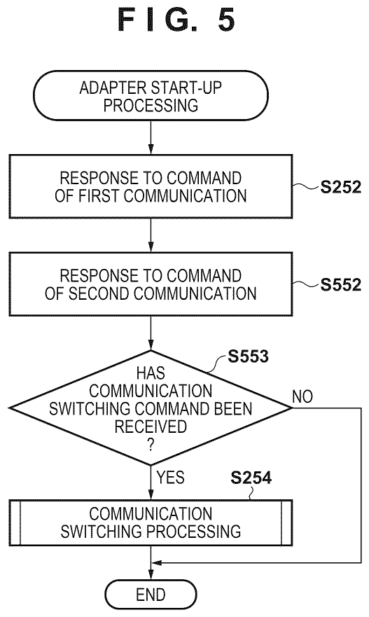

Next, processing for starting the adapter 460 will be described with reference to FIG. 5. When the adapter 460 has been mounted on the camera 100 and the power source unit 103 has started to supply power to the power source unit 164 via VDD (see step S204 of FIG. 2A), the adapter control unit 461 starts the start-up processing of the present flowchart. It is assumed that processing of each step in the present flowchart is realized by the adapter control unit 461 executing a program stored in a ROM (not shown) unless specifically stated otherwise.

In step S552, the second communication unit 107 responds to a second communication command transmitted in step S207. For example, the second communication unit 107 transmits information indicating an adapter ID, the functions that the adapter has, an adapter version, and the like in accordance with an adapter authentication sequence.

In step S553, the second communication unit 462 determines whether a communication switching command transmitted by the second communication unit 107 in step S208b has been received. In a case where the communication switching command has been received within a predetermined time period since the start of processing of step S553, processing proceeds to step S254. In a case where the communication switching command has not been received within the predetermined time period since the start of processing of step S553 (i.e., on the occurrence of a timeout without reception of the communication switching command), processing of the present flowchart is terminated. Note that the communication switching processing of step S254 is executed in accordance with the flowchart of FIG. 3, similarly to the first embodiment.

### Summary of Second Embodiment

As described above, according to the second embodiment, the adapter 460 supports the second communication in addition to the first communication. The second communication is communication based on a communication method intended for communication with an adapter including the lens mount B, and the camera 100 can recognize and authenticate the adapter 460 via the second communication after recognizing the adapter 460 via the first communication.

Therefore, the present embodiment can not only achieve advantageous effects similar to those of the first embodiment, but also enables the camera 100 to perform adapter-specific control with respect to the adapter 460. For example, in a case where firmware of the adapter 460 needs to be updated, a user can operate the update of the firmware from an adapter menu of the camera 100. Also, in a case where an error display related to the adapter 460 is necessary, the camera 100 can present such a display as an adapter-related error display. For example, in a case where the adapter 460 has been mounted on a camera that does not have a function for the third communication, an error display indicating, for example, “a mounted lens accessory may not operate accurately” can be presented on the camera. Note that as the present embodiment is characterized in that a communication switching command is transmitted in a case where a response has been made in the initial communication of the second communication in step S207 of the flowchart shown in FIG. 2A, the camera 100 may transmit the communication switching command via the first communication. Furthermore, as the adapter 160 is intended to have a function of performing the second communication, in a case where no response has been made in the initial communication of the second communication, the camera 100 may determine that a communication error has occurred, and notify the user of the occurrence of the communication error without transmitting the communication switching command. Alternatively, the camera 100 may perform the initial communication of the second communication again in a case where no response has been made in the initial communication of the second communication. Alternatively, in a case where no response has been made in the initial communication of the second communication, the camera 100 may refrain from starting the subsequent overall processing related to the third communication.

Note that in the case of the first embodiment, only the first communication intended for camera-lens communication can be performed between the camera 100 and the adapter 160. In this case, for example, in a case where firmware of the adapter 160 needs to be updated, the user can operate the update of the firmware from a lens menu of the camera 100.

### Third Embodiment

### <Configuration of Camera System>

The first and second embodiments have been described in relation to a camera system in which a communication path is partially shared by the first communication and the third communication. In contrast, a third embodiment will be described in relation to a camera system in which a communication path is partially shared by the second communication and the third communication. Note that in the description of the third embodiment, reference signs that are the same as those of the first and second embodiments are assigned to the configurations and processing that are the same as or similar to those of the first and second embodiments. The following mainly describes the differences from the first and second embodiments.

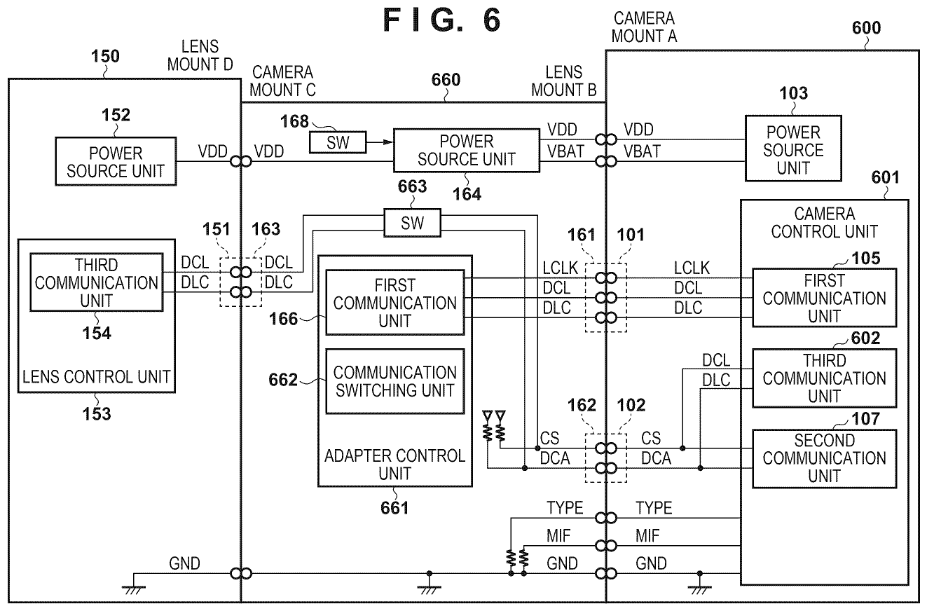

FIG. 6 is a block diagram showing a configuration of a camera system according to the third embodiment. The camera system of FIG. 6 is different from the camera system of the first embodiment (FIG. 1) in that it includes an adapter 660 in place of the adapter 160, and includes a camera 600 in place of the camera 100.

The camera 600 includes a camera control unit 601. A first communication unit 105, a second communication unit 107, and a third communication unit 602 are provided inside the camera control unit 601. Note that the camera control unit 601 is composed of one or more processors or a circuit (e.g., an ASIC) that realizes one or more functions, and each unit can be controlled by, for example, the processor(s) reading out and executing a program stored in a memory. Although the third communication unit 602 has functions similar to those of the third communication unit 106, it is different from the third communication unit 106 in being connected to the contact unit 102, rather than to the contact unit 101.

The adapter 660 includes an adapter control unit 661. A first communication unit 166 and a communication switching unit 662 are provided inside the adapter control unit 661. Note that the adapter control unit 661 is composed of one or more processors or a circuit (e.g., an ASIC) that realizes one or more functions, and each unit can be controlled by, for example, the processor(s) reading out and executing a program stored in a memory. Inside the adapter 660, the contact unit 163 is connected to the contact unit 162 via a switch 663, rather than to the contact unit 161. The switch 663 is controlled by the communication switching unit 662. When the switch 663 has been set to be active, CS and DCA of the contact unit 162 are connected to the contact unit 163. When the switch 663 has been set to be inactive, connection between CS and DCA of the contact unit 162 and the contact unit 163 is broken. In the present embodiment, the switch 663 is in an inactive state at the time of start-up of the adapter 660.

As described above, the adapter 660 includes a communication path that can be switched between a state where the third communication from the camera 100 via the contact unit 102 and the contact unit 162 does not reach the contact unit 163 (a first state) and a state where the third communication reaches the contact unit 163 (a second state). Switching of the state of the communication path is controlled by the communication switching unit 662. In a case where the communication path is in a state where the third communication reaches the contact unit 163 (the second state), the third communication reaches the third communication unit 154 from the contact unit 163 via the contact unit 151, and consequently, the camera 100 can perform the third communication with the interchangeable lens 150.

### <Processing for Starting Camera 600>

The processing for starting the camera 600 is executed in accordance with the flowchart of FIG. 2A, similarly to the first embodiment. However, as the camera 600 includes the camera control unit 601 in place of the camera control unit 104, processing of each step is executed by the camera control unit 601 (or constituent elements thereinside).

### <Processing for Starting Adapter 660>

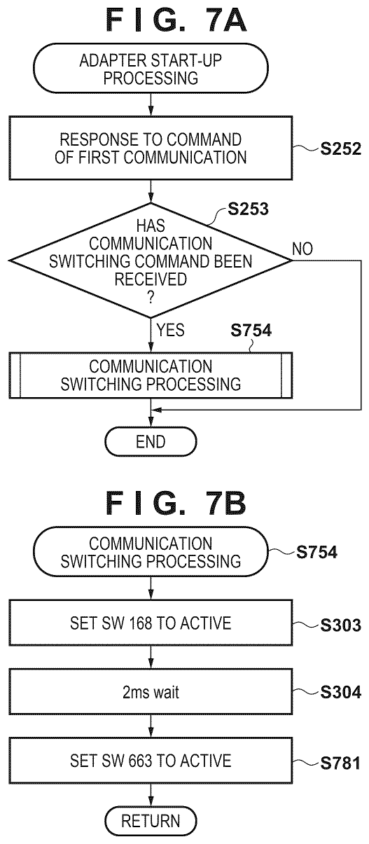

FIG. 7A is a flowchart of processing for starting the adapter 660. When the adapter 660 has been mounted on the camera 600 and the power source unit 103 has started to supply power to the power source unit 164 via VDD (see step S204 of FIG. 2A), the adapter control unit 661 starts the start-up processing of the present flowchart. It is assumed that processing of each step in the present flowchart is realized by the adapter control unit 661 executing a program stored in a ROM (not shown) unless specifically stated otherwise.

Processing of steps S252 and S253 of FIG. 7A is similar to steps S252 and S253 of FIG. 2B. However, as the adapter 660 includes the adapter control unit 661 in place of the adapter control unit 165, processing of each step is executed by the adapter control unit 661 (or constituent elements thereinside).

In step S754, the communication switching unit 662 executes communication switching processing. FIG. 7B is a flowchart showing the details of the communication switching processing in step S754.

Processing of steps S303 and S304 of FIG. 7B is similar to steps S303 and S304 of FIG. 3. However, as the adapter 660 includes the adapter control unit 661 in place of the adapter control unit 165, processing of each step is executed by the adapter control unit 661 (or constituent elements thereinside).

In step S781, the communication switching unit 662 performs control so that the switch 663, which is currently inactive, becomes active. Once the switch 663 has become active, CS and DCA of the contact unit 162 become connected to DCL and DLC of the contact unit 163. This enables the third communication transmitted from the third communication unit 602 of the camera control unit 601 to reach the third communication unit 154 of the lens control unit 153, thereby enabling the camera 100 and the interchangeable lens 150 to exchange commands between each other via the third communication. In this way, according to the present embodiment, a communication path is partially shared by the second communication and the third communication, and the communication switching unit 662 switches the communication path between the second communication and the third communication.

### Summary of Third Embodiment

As described above, as opposed to the first and second embodiments in which a communication path is partially shared by the first communication and the third communication, a communication path is partially shared by the second communication and the third communication in the third embodiment. In this case, too, advantageous effects similar to those of the first embodiment can be achieved.

Note that in present embodiment, it is assumed that the adapter 660 does not include a second communication unit. However, the second communication unit may be provided inside the adapter control unit 661, similarly to the second embodiment. In this case, similarly to the second embodiment, the camera 600 can recognize and authenticate the adapter 660 via the second communication, and transmit a communication switching command (a switching instruction) via the second communication. In this case, it is also possible to achieve advantageous effects similar to those of the second embodiment. Alternatively, the second communication unit may be provided inside the adapter control unit 661, and the camera 600 may recognize and authenticate the adapter 660 via the second communication and transmit a communication switching command (a switching instruction) via the first communication.

### Fourth Embodiment

### <Configuration of Camera System>

The first to third embodiments have been described in relation to a camera system in which the first communication is performed at first upon detection of an accessory, and then the second communication is performed. In contrast, a fourth embodiment will be described in relation to a camera system in which the second communication is performed at first upon detection of an accessory, and then the first communication is performed. Note that in the description of the fourth embodiment, reference signs that are the same as those of the first to third embodiments are assigned to the configurations and processing that are the same as or similar to those of the first to third embodiments. The following mainly describes the differences from the first to third embodiments.

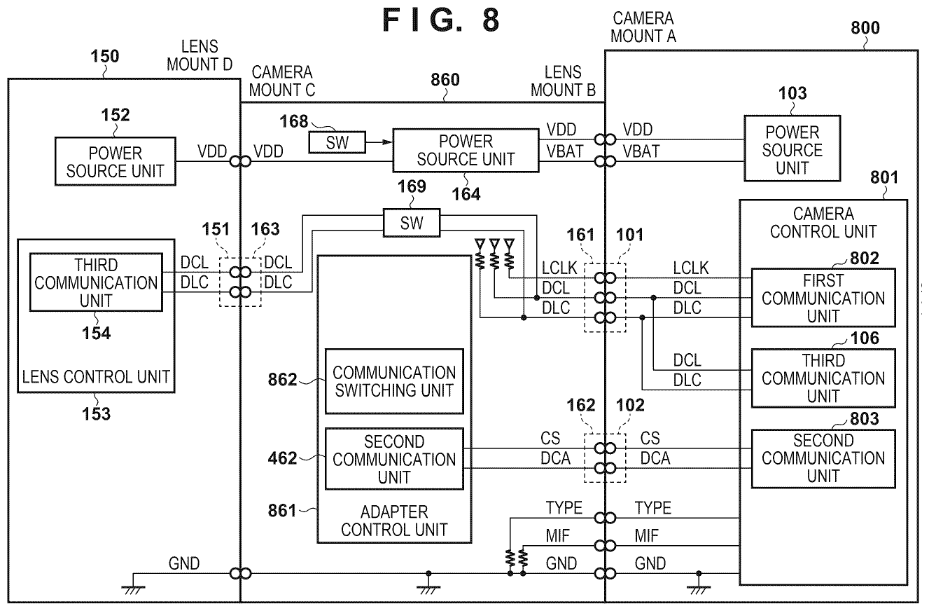

FIG. 8 is a block diagram showing a configuration of a camera system according to the fourth embodiment. The camera system of FIG. 8 is different from the camera system of the first embodiment (FIG. 1) in that it includes an adapter 860 in place of the adapter 160, and includes a camera 800 in place of the camera 100.

The camera 800 includes a camera control unit 801. A first communication unit 802, a second communication unit 803, and a third communication unit 106 are provided inside the camera control unit 801. Note that the camera control unit 801 is composed of one or more processors or a circuit (e.g., an ASIC) that realizes one or more functions, and each unit can be controlled by, for example, the processor(s) reading out and executing a program stored in a memory.

The adapter 860 includes an adapter control unit 861. A second communication unit 462 and a communication switching unit 862 are provided inside the adapter control unit 861. Note that the adapter control unit 861 is composed of one or more processors or a circuit (e.g., an ASIC) that realizes one or more functions, and each unit can be controlled by, for example, the processor(s) reading out and executing a program stored in a memory.

### <Processing for Starting Camera 800>

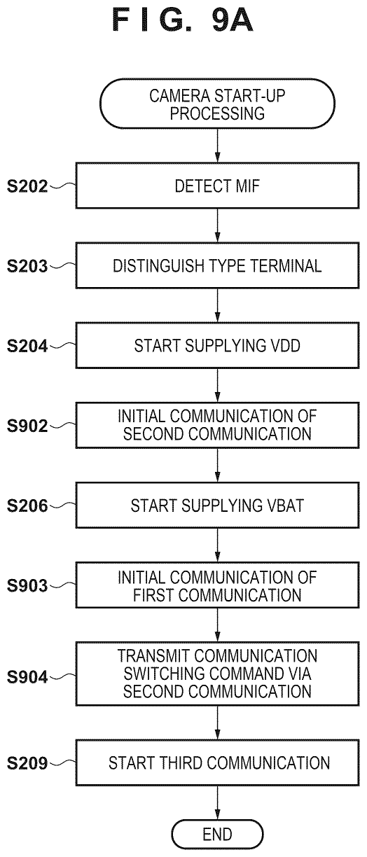

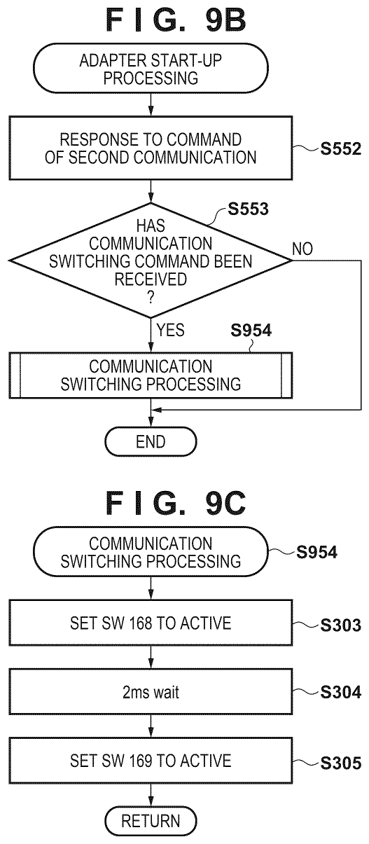

FIG. 9A is a flowchart of processing for starting the camera 800. When a user has operated a power source button (not shown) of the camera 800, a power source of the camera 800 is turned ON, and the power source unit 103 starts to supply an operating power; consequently, the camera control unit 801 starts the start-up processing of the present flowchart. It is assumed that processing of each step in the present flowchart is realized by the camera control unit 801 executing a program stored in a ROM (not shown) unless specifically stated otherwise.

Processing of steps S202 to S204, S206, and S209 of FIG. 9A is similar to steps S202 to S204, S206, and S209 of FIG. 2A. However, as the camera 800 includes the camera control unit 801 in place of the camera control unit 104, processing of each step is executed by the camera control unit 801 (or constituent elements thereinside).

In step S902, the second communication unit 803 transmits initial communication of the second communication to the second communication unit 462 of the adapter control unit 861 via the contact units 102 and 162. The details of the initial communication of the second communication are similar to step S207 of FIG. 2A according to the second embodiment. As a result, the camera control unit 801 can recognize the mounted accessory as the adapter 860, and can further authenticate the adapter 860.

In step S903, the first communication unit 802 transmits initial communication of the first communication via the contact units 101 and 161. However, in the mounted adapter 860, LCLK, DCL, and DLC of the contact unit 161 are pulled up and connected to a power source. Therefore, no response is returned to a command for the initial communication. Therefore, the first communication unit 802 performs control so that the first communication is not transmitted thereafter.

In step S904, similarly to step S208b of FIG. 2A, the second communication unit 803 uses the second communication to transmit a communication switching command for switching from the first communication to the third communication.

### <Processing for Starting Adapter 860>

FIG. 9B is a flowchart of processing for starting the adapter 860. When the adapter 860 has been mounted on the camera 800 and the power source unit 103 has started to supply power to the power source unit 164 via VDD (see step S204 of FIG. 9A), the adapter control unit 861 starts the start-up processing of the present flowchart. It is assumed that processing of each step in the present flowchart is realized by the adapter control unit 861 executing a program stored in a ROM (not shown) unless specifically stated otherwise.

Processing of steps S552 and S553 of FIG. 9B is similar to steps S552 and S553 of FIG. 5. However, as the adapter 860 includes the adapter control unit 861 in place of the adapter control unit 461, processing of each step is executed by the adapter control unit 861 (or constituent elements thereinside).

In step S954, the communication switching unit 862 executes communication switching processing to enable the execution of the third communication via the contact units 101 and 161. FIG. 9C is a flowchart showing the details of the communication switching processing in step S954.

Processing of steps S303 to S305 of FIG. 9C is similar to steps S303 to S305 of FIG. 3. However, as the adapter 860 includes the adapter control unit 861 in place of the adapter control unit 165, processing of each step is executed by the adapter control unit 861 (or constituent elements thereinside).

As a result of the communication switching processing of step S954, DCL and DLC of the contact unit 161 become connected to DCL and DLC of the contact unit 163, thereby enabling the third communication between the camera 800 and the interchangeable lens 150.

### Summary of Fourth Embodiment

As described above, in the fourth embodiment, the order of the initial communication of the first communication and the initial communication of the second communication in the specification of the start-up processing sequence for the camera 800 is the reverse of the order in the first to the third embodiments. In this case, too, advantageous effects similar to those of the first to third embodiments can be achieved.

Note that in present embodiment, it is assumed that the adapter 860 does not include a first communication unit. However, the first communication unit may be provided inside the adapter control unit 861. In this case, in step S903 of FIG. 9A, the camera 800 can obtain a response to the initial communication of the first communication from the adapter 860, similarly to the first to third embodiments. Furthermore, in this case, the camera 800 may transmit a communication switching command to the adapter 860 via the first communication.

### Fifth Embodiment

### <Configuration of Camera System>

The fourth embodiment has been described in relation to a camera system in which a communication path is partially shared by the first communication and the third communication. In contrast, a fifth embodiment will be described in relation to a camera system in which a communication path is partially shared by the second communication and the third communication. In the fifth embodiment, the second communication is performed at first upon detection of an accessory, and then the first communication is performed, similarly to the fourth embodiment. Note that in the description of the fifth embodiment, reference signs that are the same as those of the first to fourth embodiments are assigned to the configurations and processing that are the same as or similar to those of the first to fourth embodiments. The following mainly describes the differences from the first to fourth embodiments.

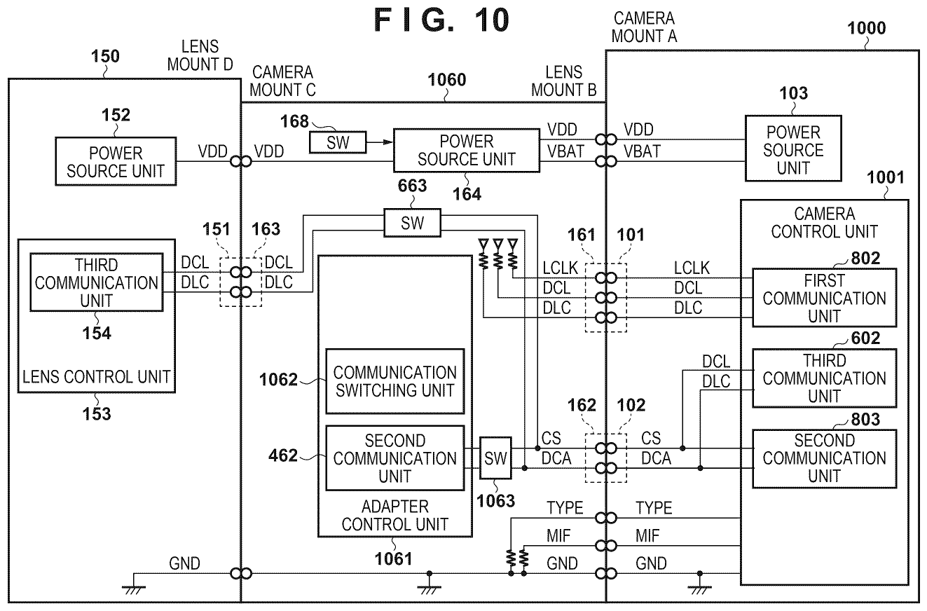

FIG. 10 is a block diagram showing a configuration of a camera system according to the fifth embodiment. The camera system of FIG. 10 is different from the camera system of the fourth embodiment (FIG. 8) in that it includes an adapter 1060 in place of the adapter 860, and includes a camera 1000 in place of the camera 800.

The camera 1000 includes a camera control unit 1001. A first communication unit 802, a second communication unit 803, and a third communication unit 602 are provided inside the camera control unit 1001. Note that the camera control unit 1001 is composed of one or more processors or a circuit (e.g., an ASIC) that realizes one or more functions, and each unit can be controlled by, for example, the processor(s) reading out and executing a program stored in a memory. Although the third communication unit 602 has functions similar to those of the third communication unit 106, it is different from the third communication unit 106 in being connected to the contact unit 102, rather than to the contact unit 101.

The adapter 1060 includes an adapter control unit 1061. A second communication unit 462 and a communication switching unit 1062 are provided inside the adapter control unit 1061. Note that the adapter control unit 1061 is composed of one or more processors or a circuit (e.g., an ASIC) that realizes one or more functions, and each unit can be controlled by, for example, the processor(s) reading out and executing a program stored in a memory.

The adapter 1060 includes a switch 1063 between the second communication unit 462 and the contact unit 162. At the time of start-up of the adapter control unit 1061, the switch 1063 is in an active state, and the contact unit 162 and the second communication unit 462 are connected. The switch 1063 is controlled by the communication switching unit 1062.

### <Processing for Starting Camera 1000>

The processing for starting the camera 1000 is executed in accordance with the flowchart of FIG. 9A, similarly to the fourth embodiment. However, as the camera 1000 includes the camera control unit 1001 in place of the camera control unit 801, processing of each step is executed by the camera control unit 1001 (or constituent elements thereinside).

### <Processing for Starting Adapter 1060>

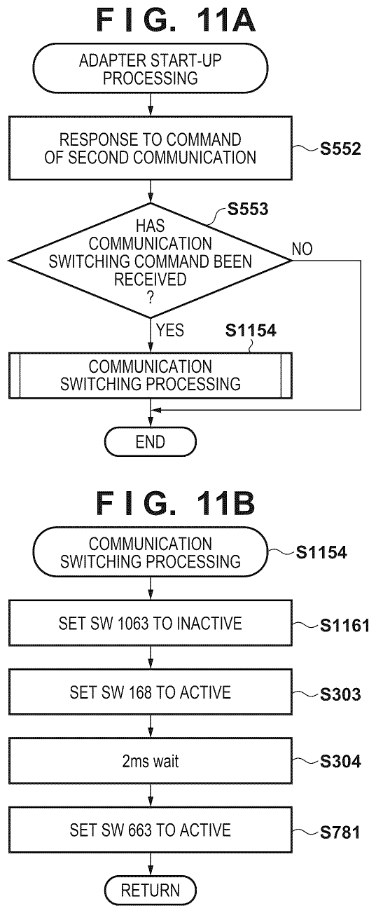

FIG. 11A is a flowchart of processing for starting the adapter 1060. When the adapter 1060 has been mounted on the camera 1000 and the power source unit 103 has started to supply power to the power source unit 164 via VDD (see step S204 of FIG. 9A), the adapter control unit 1061 starts the start-up processing of the present flowchart. It is assumed that processing of each step in the present flowchart is realized by the adapter control unit 1061 executing a program stored in a ROM (not shown) unless specifically stated otherwise.

Processing of steps S552 and S553 of FIG. 11A is similar to steps S552 and S553 of FIG. 5. However, as the adapter 1060 includes the adapter control unit 1061 in place of the adapter control unit 461, processing of each step is executed by the adapter control unit 1061 (or constituent elements thereinside).

In step S1154, the communication switching unit 1062 executes communication switching processing to enable the execution of the third communication via the contact units 101 and 161. FIG. 11B is a flowchart showing the details of the communication switching processing in step S1154.

In step S1161, the communication switching unit 1062 causes the switch 1063 to shift from an active state to an inactive state, thereby cutting off the connection between the contact unit 162 and the second communication unit 462.

Processing of steps S303 and S304 of FIG. 11B is similar to steps S303 and S304 of FIG. 3. However, as the adapter 1060 includes the adapter control unit 1061 in place of the adapter control unit 165, processing of each step is executed by the adapter control unit 1061 (or constituent elements thereinside).

Processing of step S781 of FIG. 11B is similar to step S781 of FIG. 7B. However, as the adapter 1060 includes the adapter control unit 1061 in place of the adapter control unit 661, processing of each step is executed by the adapter control unit 1061 (or constituent elements thereinside).

As a result of the communication switching processing of step S1154, CS and DLA of the contact unit 162 become connected to DCL and DLC of the contact unit 163, thereby enabling the third communication between the camera 1000 and the interchangeable lens 150.

### Summary of Fifth Embodiment

As described above, as opposed to the fourth embodiment in which a communication path is partially shared by the first communication and the third communication, a communication path is partially shared by the second communication and the third communication in the fifth embodiment. In this case, too, advantageous effects similar to those of the fourth embodiment can be achieved.

Note that a first communication unit may be provided inside the adapter control unit 1061, similarly to the fourth embodiment. In this case, the camera 1000 may transmit a communication switching command to the adapter 1060 via the first communication.

### Sixth Embodiment

### <Configuration of Camera System>

In the first to fifth embodiments, it is assumed that an adapter includes a communication path that can be switched between a state where the third communication from the camera 100 via a predetermined contact unit (the contact unit 161 in the first, second, and fourth embodiments, and the contact unit 162 in the third and fifth embodiments) does not reach the contact unit 163 (a first state) and a state where the third communication reaches the contact unit 163 (a second state). In other words, the first to fifth embodiments have been described in relation to a configuration in which the third communication shares a part of a communication path for the first communication or the second communication. In contrast, a sixth embodiment will be described in relation to a configuration in which a communication path for the third communication is independent of a communication path for the first communication and a communication path for the second communication. Note that in the description of the sixth embodiment, reference signs that are the same as those of the first to fifth embodiments are assigned to the configurations and processing that are the same as or similar to those of the first to fifth embodiments. The following mainly describes the differences from the first to fifth embodiments.

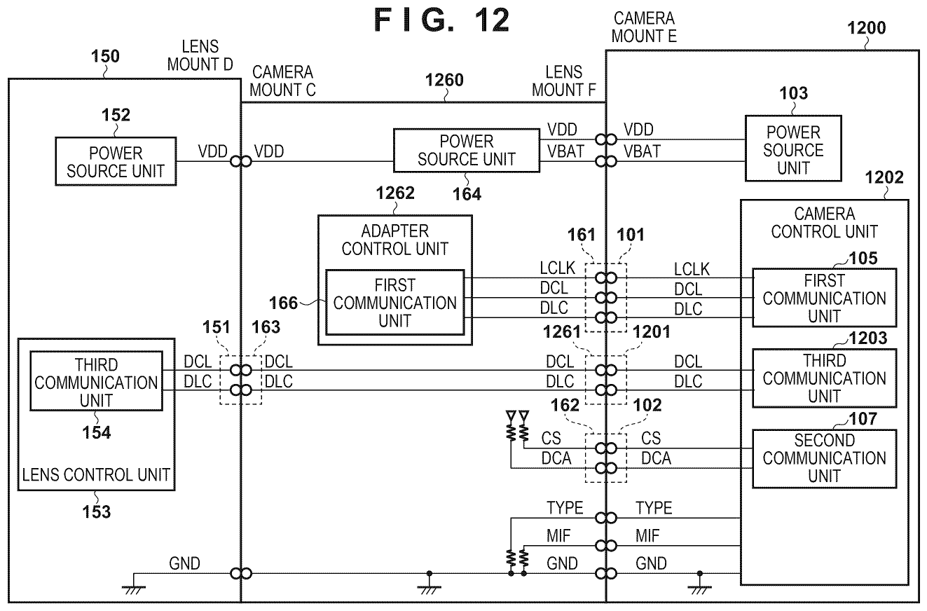

FIG. 12 is a block diagram showing a configuration of a camera system according to the sixth embodiment. The camera system of FIG. 12 is different from the camera system of the first embodiment (FIG. 1) in that it includes an adapter 1260 in place of the adapter 160, and includes a camera 1200 in place of the camera 100.

The camera 1200 includes a camera mount E. The camera mount E is a mount having a configuration obtained by adding a contact unit 1201 (a fourth contact unit) to the camera mount A. The adapter 1260 includes a lens mount F. The lens mount F is a mount having a configuration obtained by adding a contact unit 1261 (a fourth contact unit) to the lens mount B. The contact unit 1261 of the adapter 1260 is connectable to the contact unit 1201 of the camera 1200. The camera mount E and the lens mount F are connectable to each other.

In the camera 1200, the contact unit 1201 is connected to a third communication unit 1203. In the adapter 1260, the contact unit 1261 is connected to the contact unit 163.

In this way, the adapter 1260 includes a communication path that enables the third communication from the camera 1200 via the contact unit 1201 and the contact unit 1261 to reach the contact unit 163. Therefore, in the present embodiment, the third communication unit 1203 in the camera 1200 is connected to the third communication unit 154 of the interchangeable lens 150 and is in a state where it can execute the third communication without switching the communication path. Note that the camera control unit 1202 is composed of one or more processors or a circuit (e.g., an ASIC) that realizes one or more functions, and each unit can be controlled by, for example, the processor(s) reading out and executing a program stored in a memory. Also, the adapter control unit 1262 is composed of one or more processors or a circuit (e.g., an ASIC) that realizes one or more functions, and each unit can be controlled by, for example, the processor(s) reading out and executing a program stored in a memory.

### <Processing for Starting Camera 1200>

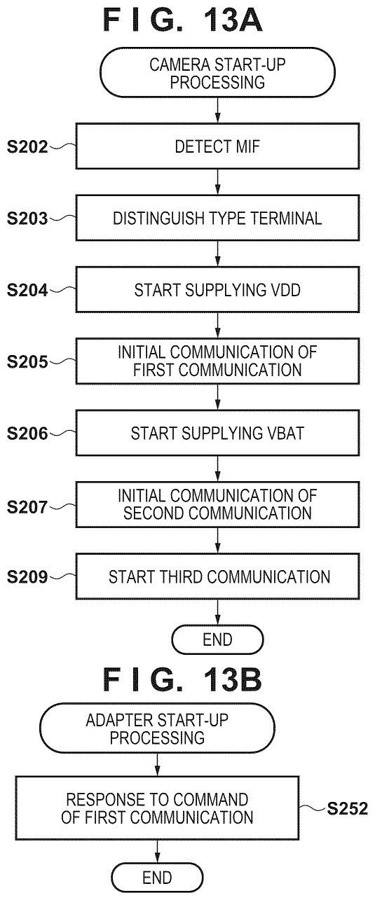

FIG. 13A is a flowchart of processing for starting the camera 1200. When a user has operated a power source button (not shown) of the camera 1200, a power source of the camera 1200 is turned ON, and the power source unit 103 starts to supply an operating power; consequently, the camera control unit 1202 starts the start-up processing of the present flowchart. It is assumed that processing of each step in the present flowchart is realized by the camera control unit 1202 executing a program stored in a ROM (not shown) unless specifically stated otherwise.

Processing of steps S202 to S207 and step S209 of FIG. 13A is similar to steps S202 to S207 and step S209 of FIG. 2A. However, as the camera 1200 includes the camera control unit 1202 in place of the camera control unit 104, processing of each step is executed by the camera control unit 1202 (or constituent elements thereinside). Also, CS and DCA of the contact unit 162 in the adapter 1260 are pulled up to a power source; therefore, in step S207, even if the second communication unit 107 has transmitted a command, no response is returned, similarly to the first embodiment.

In the present embodiment, the adapter 1260 is recognized via the first communication in step S205. As stated earlier, the third communication unit 1203 and the third communication unit 154 are connected via the contact units 1261 and 163 in the adapter 1260; therefore, the camera 1200 can perform the third communication with the interchangeable lens 150 without issuing a communication switching instruction. Accordingly, in FIG. 13A, the third communication is started in step S209 following the initial communication of the second communication in step S207.

### <Processing for Starting Adapter 1260>

FIG. 13B is a flowchart of processing for starting the adapter 1260. When the adapter 1260 has been mounted on the camera 1200 and the power source unit 103 has started to supply power to the power source unit 164 via VDD (see step S204 of FIG. 13A), the adapter control unit 1262 starts the start-up processing of the present flowchart. It is assumed that processing of each step in the present flowchart is realized by the adapter control unit 1262 executing a program stored in a ROM (not shown) unless specifically stated otherwise.

Processing of step S252 of FIG. 13B is similar to step S252 of FIG. 3. However, as the adapter 1260 includes the adapter control unit 1262 in place of the adapter control unit 165, processing of step S252 is executed by the adapter control unit 1262 (or constituent elements thereinside).

### Summary of Sixth Embodiment

As described above, according to the sixth embodiment, the camera system includes the camera 1200 that supports the first communication, second communication, and third communication, the adapter 1260 that supports the first communication, and the interchangeable lens 150 that supports the third communication. The specification of the start-up processing sequence for the camera 100 is configured to, in a case where an accessory has been detected, perform initial communication of the first communication at first, and then perform initial communication of the second communication. The interchangeable lens 150 including the lens mount D does not support the first communication, unlike an interchangeable lens including the lens mount B. However, as the adapter 1260 supports the first communication, the camera 1200 can receive a response to a command for the initial communication of the first communication, and recognize the adapter 1260 on the basis of the response. The adapter 1260 includes a communication path that enables the third communication from the camera 1200 via the contact unit 1201 and the contact unit 1261 to reach the contact unit 163.

Therefore, the present embodiment enables the camera 1200 to communicate with the interchangeable lens 150 in a situation where the interchangeable lens 150, which does not support the specification of camera-lens communication (the first communication) for an interchangeable lens including the lens mount F (an interchangeable lens directly mountable on the camera 1200) and which supports a different specification of communication (the third communication), is mounted on the camera 1200 via the adapter 1260. Furthermore, as the camera 1200 can recognize the adapter 1260 via the first communication with the adapter 1260, startup processing for the camera 1200 can be executed in accordance with the same start-up processing sequence (a sequence in which the initial communication of the first communication is performed at first, and then the initial communication of the second communication is performed, in a case where an accessory has been detected), regardless of whether the interchangeable lens mounted on the camera 1200 supports the specification of the first communication.

Note that in present embodiment, it is assumed that the adapter 1260 does not include a second communication unit. However, the second communication unit may be provided inside the adapter control unit 1262. In this case, in step S207 of FIG. 13A, the camera 1200 can obtain a response to the initial communication of the second communication from the adapter 1260, and recognize and authenticate the adapter 1260 on the basis of the response, similarly to the second embodiment. In this case, a specification in which the initial communication of the first communication is performed before the initial communication of the second communication may be adopted as a specification of the start-up processing sequence for the camera 1200, similarly to the fourth and fifth embodiments. Generally speaking, in the sixth embodiment, it is sufficient for the adapter 1260 to include at least one of the first communication unit that performs the first communication and the second communication unit that performs the second communication, and the camera 1200 recognizes the adapter 1260 via the first communication or the second communication.

### OTHER EMBODIMENTS

The above embodiments have been described in relation to a configuration in which power to be supplied to the interchangeable lens 150 is increased in voltage inside an adapter. However, it is permissible to adopt a configuration in which power to be supplied to the interchangeable lens 150 is increased in voltage inside a camera, and the power is supplied to the interchangeable lens 150 after the camera has recognized an adapter.

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While one or more features of the present disclosure have been described with reference to exemplary embodiments, it is to be understood that the scope of the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-085658, filed May 27, 2024, which is hereby incorporated by reference herein in its entirety.

What is claimed is:

1. An image capturing apparatus comprising:
a first contact unit connectable to a first contact unit of an adapter;
a second contact unit connectable to a second contact unit of the adapter; and
at least one processor which functions as:
a first communication unit that operates to perform a first communication via the first contact unit of the image capturing apparatus;
a second communication unit that operates to perform a second communication via the second contact unit of the image capturing apparatus;
a third communication unit that operates to perform a third communication via a predetermined contact unit that is the first contact unit or the second contact unit of the image capturing apparatus; and
a control unit,
wherein:
the adapter includes a communication path that operates to be switched between a first state where the third communication from the image capturing apparatus does not reach a third contact unit of the adapter, and a second state where the third communication reaches the third contact unit of the adapter,
the third contact unit of the adapter is connectable to a third contact unit of an interchangeable lens, and
the control unit of the image capturing apparatus operates to perform a control to:
recognize the adapter via the first communication or the second communication while the communication path is in the first state,
after recognizing the adapter, transmit a switching instruction instructing to switch the communication path to the second state via the first communication or the second communication, and
start the third communication after transmitting the switching instruction.

2. The image capturing apparatus according to claim 1, wherein
the control unit further operates to:
transmit a first command via the first communication, and
recognize the adapter on a basis of a response to the first command received from the adapter via the first communication.

3. The image capturing apparatus according to claim 1, wherein
the predetermined contact unit of the image capturing apparatus is the first contact unit of the image capturing apparatus.

4. The image capturing apparatus according to claim 1, wherein
the control unit further operates to:
transmit a second command via the second communication after recognizing the adapter, and
transmit the switching instruction via the first communication or the second communication after transmitting the second command.

5. The image capturing apparatus according to claim 4, wherein
the control unit further operates to:
transmit the switching instruction via the second communication in a case where a response to the second command has been received from the adapter via the second communication, and
transmit the switching instruction via the first communication in a case where the response to the second command has not been received.

6. The image capturing apparatus according to claim 1, wherein
the predetermined contact unit of the image capturing apparatus is the second contact unit of the image capturing apparatus.

7. The image capturing apparatus according to claim 1, wherein
the control unit further operates to:
transmit a second command via the second communication, and
recognize the adapter on a basis of a response to the second command received from the adapter via the second communication.

8. The image capturing apparatus according to claim 7, wherein
the control unit further operates to:
transmit a first command via the first communication after recognizing the adapter, and
transmit the switching instruction via the second communication after transmitting the first command.

9. The image capturing apparatus according to claim 7, wherein
the predetermined contact unit of the image capturing apparatus is the first contact unit of the image capturing apparatus.

10. The image capturing apparatus according to claim 7, wherein
the predetermined contact unit of the image capturing apparatus is the second contact unit of the image capturing apparatus.

11. The image capturing apparatus according to claim 1, wherein
the third communication is a communication standard capable of communicating with an interchangeable lens that does not support the first communication and the second communication.

12. An image capturing apparatus comprising:
a first contact unit;
a second contact unit; and
at least one processor which functions as:
a first communication unit that operates to perform a first communication via the first contact unit;
a second communication unit that operates to perform a second communication via the second contact unit;
a third communication unit that operates to perform a third communication via a predetermined contact unit that is the first contact unit or the second contact unit of the image capturing apparatus; and
a control unit,
wherein:
the control unit operates to perform a control to:
recognize a mounted adapter via the first communication or the second communication,
after recognizing the adapter, transmit an instruction to the adapter, and
start the third communication after transmitting the instruction.

13. An adapter comprising:
a first contact unit connectable to a first contact unit of an image capturing apparatus;
a second contact unit connectable to a second contact unit of the image capturing apparatus;
a third contact unit connectable to a third contact unit of an interchangeable lens;
at least one processor which functions as at least one of: a first communication unit that operates to perform a first communication via the first contact unit of the adapter, and a second communication unit that operates to perform a second communication via the second contact unit of the adapter; and
a communication path that operates to be switched between: (i) a first state where third communication from the image capturing apparatus via a predetermined contact unit does not reach the third contact unit of the adapter, and (ii) a second state where the third communication reaches the third contact unit of the adapter, the predetermined contact unit being the first contact unit or the second contact unit of the adapter,
wherein the at least one processor further functions as a control unit that operates to perform a control to switch the communication path to the second state in response to a reception of a switching instruction instructing to switch the communication path to the second state from the image capturing apparatus via the first communication or the second communication while the communication path is in the first state.

14. The adapter according to claim 13, wherein:
the at least one processor functions as the first communication unit, and
the control unit further operates to transmit, to the image capturing apparatus via the first communication, a response to a first command in response to a reception of the first command from the image capturing apparatus via the first communication.

15. The adapter according to claim 14, wherein:
the switching instruction is received via the first communication, and
the predetermined contact unit of the adapter is the first contact unit of the adapter.

16. The adapter according to claim 14, wherein:
the at least one processor functions as the second communication unit,
the control unit further operates to transmit, to the image capturing apparatus via the second communication, a response to a second command in response to a reception of the second command from the image capturing apparatus via the second communication,
the switching instruction is received via the second communication, and
the predetermined contact unit of the adapter is the first contact unit of the adapter.

17. The adapter according to claim 14, wherein:
the switching instruction is received via the first communication, and
the predetermined contact unit of the adapter is the second contact unit of the adapter.

18. The adapter according to claim 13, wherein:
the at least one processor functions as the second communication unit,
the control unit further operates to transmit, to the image capturing apparatus via the second communication, a response to a second command in response to a reception of the second command from the image capturing apparatus via the second communication, and
the switching instruction is received via the second communication.

19. The adapter according to claim 18, wherein
the predetermined contact unit of the adapter is the first contact unit of the adapter.

20. The adapter according to claim 18, wherein
the predetermined contact unit of the adapter is the second contact unit of the adapter.

21. The adapter according to claim 13, wherein
the third communication is a communication standard capable of communicating with an interchangeable lens that does not support the first communication and the second communication.

22. An adapter comprising:
a first contact unit;
a second contact unit;
a third contact unit;
at least one processor which functions as at least one of: a first communication unit that operates to perform a first communication via the first contact unit, and a second communication unit that operates to perform a second communication via the second contact unit; and
a communication path that operates to be switched between: (i) a first state where a third communication via a predetermined contact unit does not reach the third contact unit, and (ii) a second state where the third communication reaches the third contact unit, the predetermined contact unit being the first contact unit or the second contact unit,
wherein the at least one processor further functions as a control unit that operates to perform a control to switch the communication path to the second state in response to a reception of an instruction via the first communication or the second communication while the communication path is in the first state.

23. A system comprising:
the image capturing apparatus according to claim 1; and
an adapter including:
a first contact unit connectable to a first contact unit of an image capturing apparatus;
a second contact unit connectable to a second contact unit of the image capturing apparatus;
a third contact unit connectable to a third contact unit of an interchangeable lens;
at least one processor which functions as at least one of: a first communication unit that operates to perform a first communication via the first contact unit of the adapter, and a second communication unit that operates to perform a second communication via the second contact unit of the adapter; and
a communication path that operates to be switched between: (i) a first state where third communication from the image capturing apparatus via a predetermined contact unit does not reach the third contact unit of the adapter, and (ii) a second state where the third communication reaches the third contact unit of the adapter, the predetermined contact unit being the first contact unit or the second contact unit of the adapter,
wherein the at least one processor further functions as a control unit that operates to perform a control to switch the communication path to the second state in response to a reception of a switching instruction instructing to switch the communication path to the second state from the image capturing apparatus via the first communication or the second communication while the communication path is in the first state.

24. A control method executed by an image capturing apparatus having: a first contact unit connectable to a first contact unit of an adapter; a second contact unit connectable to a second contact unit of the adapter; and at least one processor which functions as: a first communication unit that operates to perform a first communication via the first contact unit of the image capturing apparatus; a second communication unit that operates to perform a second communication via the second contact unit of the image capturing apparatus; and a third communication unit that operates to perform a third communication via a predetermined contact unit that is the first contact unit or the second contact unit of the image capturing apparatus, wherein the adapter includes a communication path that operates to be switched between a first state where the third communication from the image capturing apparatus does not reach a third contact unit of the adapter, and a second state where the third communication reaches the third contact unit of the adapter, and the third contact unit of the adapter is connectable to a third contact unit of an interchangeable lens, the control method comprising:
performing a control to:
recognize the adapter via the first communication or the second communication while the communication path is in the first state;
after recognizing the adapter, transmit a switching instruction instructing to switch the communication path to the second state via the first communication or the second communication; and
start the third communication after transmitting the switching instruction.

25. A control method executed by an adapter including: a first contact unit connectable to a first contact unit of an image capturing apparatus; a second contact unit connectable to a second contact unit of the image capturing apparatus; a third contact unit connectable to a third contact unit of an interchangeable lens; at least one processor which functions as at least one of a first communication unit that operates to perform a first communication via the first contact unit of the adapter, and a second communication unit that operates to perform a second communication via the second contact unit of the adapter; and a communication path that operates to be switched between: (i) a first state where a third communication from the image capturing apparatus via a predetermined contact unit does not reach the third contact unit of the adapter, and (ii) a second state where the third communication reaches the third contact unit of the adapter, the predetermined contact unit being the first contact unit or the second contact unit of the adapter, the control method comprising:
performing control to switch the communication path to the second state in response to a reception of a switching instruction instructing to switch the communication path to the second state from the image capturing apparatus via the first communication or the second communication while the communication path is in the first state.

26. An image capturing apparatus comprising:
a first contact unit connectable to a first contact unit of an adapter;
a second contact unit connectable to a second contact unit of the adapter;
a fourth contact unit connectable to a fourth contact unit of the adapter; and
at least one processor which functions as:
a first communication unit that operates to perform a first communication via the first contact unit of the image capturing apparatus;
a second communication unit that operates to perform a second communication via the second contact unit of the image capturing apparatus;
a third communication unit that operates to perform a third communication via the fourth contact unit of the image capturing apparatus; and
a control unit,
wherein:
the adapter includes a communication path that causes the third communication from the image capturing apparatus to reach a third contact unit of the adapter,
the third contact unit of the adapter is connectable to a third contact unit of an interchangeable lens, and
the control unit of the image capturing apparatus operates to perform control to:
recognize the adapter via the first communication or the second communication, and
start the third communication after recognizing the adapter.

27. An adapter comprising:
a first contact unit connectable to a first contact unit of an image capturing apparatus;
a second contact unit connectable to a second contact unit of the image capturing apparatus;
a fourth contact unit connectable to a fourth contact unit of the image capturing apparatus;
a third contact unit connectable to a third contact unit of an interchangeable lens;
at least one processor which functions as at least one of: a first communication unit that operates to perform a first communication via the first contact unit of the adapter, and a second communication unit that operates to perform a second communication via the second contact unit of the adapter; and
a communication path that operates to cause a third communication from the image capturing apparatus via the fourth contact unit of the adapter to reach the third contact unit of the adapter.

28. An image capturing apparatus comprising:
a first contact unit;
a second contact unit;
a fourth contact unit; and
at least one processor which functions as:
a first communication unit that operates to perform a first communication via the first contact unit;
a second communication unit that operates to perform a second communication via the second contact unit;
a third communication unit that operates to perform a third communication via the fourth contact unit; and
a control unit,
wherein:
the control unit operates to perform control to:
recognize a mounted adapter via the first communication or the second communication, and
start the third communication after recognizing the adapter.

29. An adapter comprising:
a first contact unit;
a second contact unit;
a fourth contact unit;
a third contact unit;
at least one processor which functions as at least one of: a first communication unit that operates to perform a first communication via the first contact unit, and a second communication unit that operates to perform a second communication via the second contact unit; and
a communication path that operates to cause a third communication via the fourth contact unit to reach the third contact unit.

30. A system comprising:
the image capturing apparatus according to claim 26; and
an adapter including:
a first contact unit connectable to a first contact unit of an image capturing apparatus;
a second contact unit connectable to a second contact unit of the image capturing apparatus;
a fourth contact unit connectable to a fourth contact unit of the image capturing apparatus;
a third contact unit connectable to a third contact unit of an interchangeable lens;
at least one processor which functions as at least one of: a first communication unit that operates to perform a first communication via the first contact unit of the adapter, and a second communication unit that operates to perform a second communication via the second contact unit of the adapter; and
a communication path that operates to cause a third communication from the image capturing apparatus via the fourth contact unit of the adapter to reach the third contact unit of the adapter.

31. A control method executed by an image capturing apparatus including: a first contact unit connectable to a first contact unit of an adapter; a second contact unit connectable to a second contact unit of the adapter; a fourth contact unit connectable to a fourth contact unit of the adapter; and at least one processor which functions as: a first communication unit that operates to perform a first communication via the first contact unit of the image capturing apparatus; a second communication unit that operates to perform a second communication via the second contact unit of the image capturing apparatus; and a third communication unit that operates to perform a third communication via the fourth contact unit of the image capturing apparatus, wherein the adapter includes a communication path that operates to cause the third communication from the image capturing apparatus to reach a third contact unit of the adapter, the third contact unit of the adapter is connectable to a third contact unit of an interchangeable lens, the control method comprising:
performing a control to:
recognize the adapter via the first communication or the second communication, and
start the third communication after recognizing the adapter.
